(19) United States
(12) Patent Application Publication
(10) Pub. No.: US 2026/0056737 A1
(43) Pub. Date: Feb. 26, 2026

(54) MATRIX MULTIPLY ENGINE

(71) Applicant: SiFive, Inc., Santa Clara, CA (US)

(72) Inventors: David John Simpson, San Jose, CA (US); Krste Asanovic, Oakland, CA (US); Andrew Waterman, San Mateo, CA (US); Michael Todd Ruff, Richardson, TX (US)

(73) Assignee: SiFive, Inc., Santa Clara, CA (US)

(21) Appl. No.: 19/042,659

(22) Filed: Jan. 31, 2025

Related U.S. Application Data
(63) Continuation of application No. 18/814,386, filed on Aug. 23, 2024.

(51) Int. Cl. G06F 9/30; G06F 17/16

(52) U.S. Cl. CPC G06F 9/3001; G06F 17/16

(57) ABSTRACT

A matrix multiply engine can include a first operand buffer and a second operand buffer, each of which can store multiple operand elements arranged in rows and columns. A cell array can be formed of cells, where each cell includes a memory and accumulator circuitry to receive operand elements column-wise from each of the first operand buffer and the second operand buffer, to compute a dot product of the received operand elements, and to accumulate the dot product into a corresponding tile state element in the memory. Matrix elements of the operand matrices to be multiplied can be loaded row-wise into rows of the operand buffers and read column-wise into the cells. The number of elements for which a dot product is computed can be selected depending on operand element width.

### CROSS-REFERENCES TO RELATED APPLICATIONS

This application is a continuation of U.S. application Ser. No. 18/814,386, filed Aug. 23, 2024, the disclosure of which is incorporated herein by reference.

### BACKGROUND

This disclosure relates generally to processing circuitry and in particular to a matrix multiply engine.

Some computer algorithms can be extremely computationally intensive. For instance, algorithms used to implement machine learning techniques, including neural networks, transformers, and the like, rely on multiplication of large matrices, which involves an even larger number of scalar multiplication operations. For instance, computing the product of two n×n matrices naively requires n³ scalar multiplication operations. Accordingly, techniques to accelerate the computation of matrix multiplications are desirable.

Some known techniques for accelerating matrix multiplication include using parallel processing to perform different scalar multiplications in parallel. Vector processors that can execute the same instruction on different data elements in parallel have been used. More recently, dedicated matrix multiplication circuits have been developed to further exploit parallel processing.

### SUMMARY

Certain embodiments described herein relate to matrix multiply engines that can increase arithmetic intensity as operand width decreases by computing dot products of multiple elements of an operand matrix in an operating cycle. For example, a matrix multiply engine can be implemented in a circuit having a first operand buffer and a second operand buffer, each of which can have storage locations for multiple operand elements. The storage locations in each operand buffer can be arranged in rows and columns. A cell array can be formed of cells, where each cell includes a memory (e.g., addressable memory circuitry to store one or more tile state elements) and accumulator circuitry to receive operand elements column-wise from each of the first operand buffer and the second operand buffer, to compute a dot product of the received operand elements, and to accumulate the dot product into a corresponding tile state element in the memory. Matrix elements of the operand matrices to be multiplied can be loaded row-wise into rows of the operand buffers and read column-wise into the cells. The cells can thus compute a dot product from two column vectors having a length (number of elements) TK. In some embodiments, TK can depend on a width of the operand elements, with TK increasing as the width of the operand elements decreases. Readout circuitry can be provided to read out tile state elements from the memory of the cells; in some embodiments, readout can be selectably performed for a row of cells or a column of cells.

The following detailed description, together with the accompanying drawings, will provide a better understanding of the nature and advantages of the claimed invention.

### BRIEF DESCRIPTION OF THE DRAWINGS

FIG. 1 shows a simplified high-level block diagram of a processor system incorporating a matrix multiply engine according to some embodiments.

FIG. 2 shows a simplified block diagram illustrating additional features of a matrix multiply engine according to some embodiments.

FIG. 3 illustrates an operating principle for multiplication of large matrices according to some embodiments.

FIGS. 4A-4D show simplified schematic diagrams of a circuit that can be used to implement a cell in a matrix multiply engine according to some embodiments.

FIGS. 5A-5B and FIGS. 6A-6B illustrate an operating principle for a cell in a matrix multiply engine according to some embodiments.

FIGS. 7A and 7B illustrate writing and reading for an operand buffer according to some embodiments.

FIGS. 8A-8C and FIGS. 9A-9I show examples of arranging operand matrix elements in an operand buffer according to some embodiments.

FIGS. 10A and 10B show examples of element arrangements on a vector buffer interface bus according to some embodiments.

FIG. 11 shows a flow diagram of a process for determining certain run-time parameters for a matrix multiply operation according to some embodiments.

FIGS. 12A and 12B show examples of tile-based addressing in a tile state memory according to some embodiments.

FIG. 13 shows a flow diagram of a process for computing the address of an element in a tile state memory according to some embodiments.

FIG. 14 shows an example of element interleaving in a tile state memory according to some embodiments.

FIGS. 15A and 15B show examples of element interleaving for small matrices according to some embodiments.

FIG. 16 shows a simplified block diagram of a matrix multiply engine according to some embodiments.

FIG. 17 shows a simplified block diagram of a system including a matrix multiply engine according to some embodiments.

FIGS. 18A and 18B show examples of tile-based addressing in a tile state memory according to some embodiments.

FIG. 19 shows a block diagram of a system for generation and manufacture of integrated circuits according to some embodiments.

### DETAILED DESCRIPTION

The following description of exemplary embodiments of the invention is presented for the purpose of illustration and description. It is not intended to be exhaustive or to limit the claimed invention to the precise form described, and persons skilled in the art will appreciate that many modifications and variations are possible. The embodiments have been chosen and described in order to best explain the principles of the invention and its practical applications to thereby enable others skilled in the art to best make and use the invention in various embodiments and with various modifications as are suited to the particular use contemplated.

### Overview

Embodiments described herein relate to a type of processing circuit referred to herein as a “matrix multiply engine.” Such circuits incorporate arithmetic logic units, buffers, and other circuits configured (via physical layout) to accelerate matrix multiplication operations. In mathematics, matrix multiplication is defined as follows: If A is matrix having dimensions M×K with elements aᵢⱼ (where 0≤i≤M−1, 0≤j≤K−1) and B is a matrix having dimensions K×N with elements bᵢⱼ (where 0≤i≥K−1, 0≤j≤N−1), the product C=A*B is a matrix having dimensions M× N whose elements cᵢⱼ are given by:

$${c}_{ij} = {\sum }_{k = 0}^{K - 1} {a}_{ik} {b}_{kj} . \qquad ( 1 )$$

The operation of Eq. (1) can also be understood as computing the dot product of two k-component vectors, with one vector being the ith row of matrix A and the other vector being the jth column of matrix B.

Matrix multiplication is heavily used in machine learning algorithms, including many neural network algorithms. As can be seen from Eq. (1), matrix multiplication can be computationally intensive, particularly for large matrices. Matrix multiply engines of the kind described herein can accelerate these computations, improving performance of processors and/or computer systems that execute algorithms incorporating matrix multiplication.

According to some embodiments, for large operand matrices, a matrix multiply engine can compute the product by performing multiply-accumulate operations sequentially on different patches of the input matrix, with the patch dimensions being selected based in part on the width of the operands (e.g., the elements of the matrices being multiplied). In particular, the patches for a multiply-accumulate operation are selected such that the dimensionality (number of vector components) of the dot product computed in a given multiply-accumulate operation increases with decreasing operand width. As described below, for operand matrices A and B stored in memory in row-major order, with A having dimensions K×M and B having dimensions K×N, a matrix multiply engine can perform the computation C=A^{T}*B, where A^{T} is the matrix transpose of the A operand matrix stored in memory. Matrix multiply engines of the kind described herein can provide increased arithmetic intensity as compared to other matrix multiply engines (including engines that compute C=A*B^{T} for operand matrices A and B stored in memory in row-major order).

The following sections describe examples of matrix multiply engines according to various embodiments, as well as additional examples of systems that can incorporate a matrix multiply engine according to various embodiments.

### Matrix Multiply Engine Examples

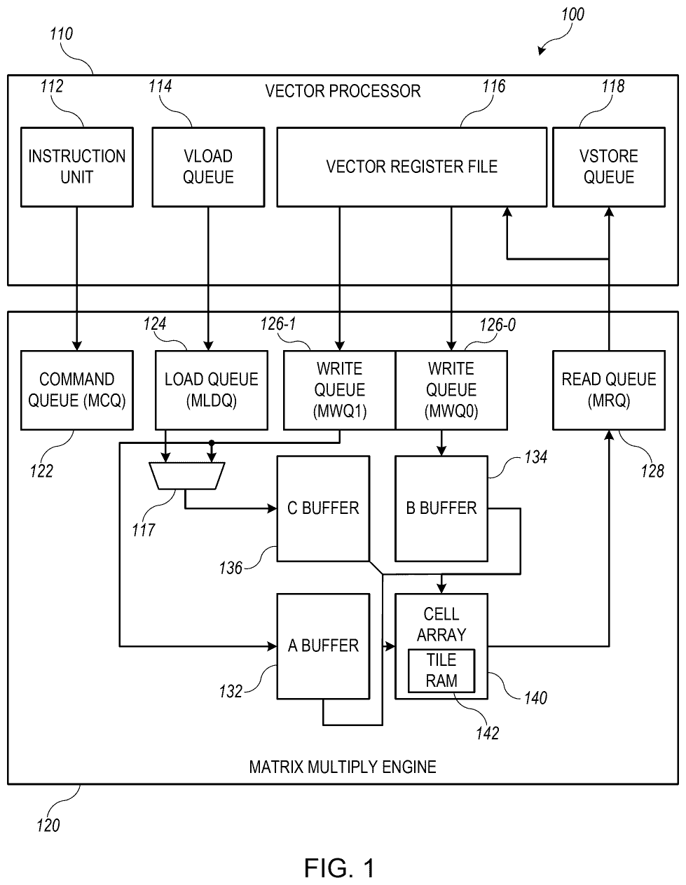

FIG. 1 shows a simplified high-level block diagram of a processor system 100 incorporating a matrix multiply engine according to some embodiments. Processor system 100 includes a vector processor 110 and a matrix multiply engine 120. Vector processor 110 can be of conventional or other design and can include a vector instruction unit 112, a vector load (VLOAD) queue 114, a vector register file 116, and a vector store (VSTORE) queue 118. Vector processor 110 can also include other components (not shown) such as execution units and interfaces to a scalar processor that uses vector processor 110 as a coprocessor. Instruction unit 112 can receive instructions to execute and initiate execution of received instructions by vector processor 110. Instruction unit 112 can also selectively dispatch instructions for matrix multiplication operations to matrix multiply engine 120.

Vector register file 116 can include a number of data registers (or rows), where each row has a fixed width (VLEN). The width VLEN is a design parameter of the circuit and can be chosen to be long enough to store multiple data elements, thereby supporting parallel execution of an operation on different data elements. For example, VLEN can be in the range from 64 bits to 64K bits and can be constrained to be a power of 2 for simplicity of implementation. In some examples herein, VLEN is 1024 bits. The number of data elements stored in a row of vector register file 116 also depends on the width of each data element. In some embodiments, processor system 100 can support application-specific element widths that can be specified at runtime. For instance, if VLEN=1024 bits, a row can store up to 128 8-bit data elements, up to 64 16-bit data elements, up to 32 32-bit data elements, or up to 16 64-bit data elements. Vector register file 116 can be used to store source operands and/or results of operations executed within vector processor 110. In addition, vector register file 116 can be used as a source of operands for and/or a destination for output data from matrix multiply engine 120.

Vector load (VLOAD) queue 114 can load vector data from a memory circuit (not shown) into vector register file 116. The memory circuit, which can be implemented using any type of random-access memory (RAM) or other addressable storage circuitry, can be external to vector processor 110; for instance, the memory circuit can be system memory. In some instances, the vector data can represent elements of an operand matrix or result matrix for matrix multiplication, and in such instances vector load queue 114 can forward vector data to matrix multiply engine 120, bypassing vector register file 116. Similarly, vector store (VSTORE) queue 118 can store data from vector register file 116 or data received from matrix multiply engine 120 into external memory.

The particular architecture of vector processor 110 can be modified as desired. For instance, some embodiments, vector processor 110 can support the vector extension of the RISC-V instruction set architecture (ISA). It is also assumed that the instruction set supported by vector processor 110 also includes a group of instructions that are specific to matrix multiplication. In some embodiments, these “matmul” instructions can be defined as an additional RISC-V extension, separate from the vector extension. Instruction unit 112 can recognize matmul instructions and route such instructions to matrix multiply engine 120 for execution.

Matrix multiply engine 120 includes components that interface with vector processor 110. In this example, the interface components include a command queue (MCQ) 122, a load queue (MLDQ) 124, write queues (MWQ0) 126-0 and (MWQ1) 126-1, and a read queue (MRQ) 128. Matrix multiply engine 120 can also include operand buffers 132, 134 to store elements of operand matrices A and B and a cell array 140 to execute multiplication and accumulation operations on operands from operand buffers 132, 134 and update elements of a product matrix C. In some embodiments, elements of the product matrix C can be stored in cell array 140, e.g., in a tile state RAM 142. (As described below, tile state RAM 142 can be implemented using multiple memory circuits.) The number of elements in product matrix C may exceed the storage capacity of tile state RAM 142, in which case it may be useful to move under-construction elements of product matrix C between tile state RAM 142 and external memory. In some embodiments, a C buffer 136 can be provided to facilitate such operations.

Command queue 122 can receive instructions from vector processor 110 (e.g., from instruction unit 112) and can dispatch appropriate operations (e.g., read, write, and execution operations) to various components of matrix multiply engine 120. Load queue 124 can receive vector data read from memory into VLOAD queue 114 and provide the vector data to operand buffers 132, 134, 136. Write queues 126-0 and 126-1 can receive vector data from vector register file 116 and provide the vector data to operand buffers 132, 134, 136. In some embodiments, data from either load queue 124 or one of write queues 126-0, 126-1 can be selectably delivered to operand buffers 132, 134, 136; for instance, multiplexer 117 supports delivery of data from either load queue 124 or write queue 126-1 to C buffer 136.

Cell array 140 can include a number of arithmetic logic units (ALUs) that are configured to perform scalar multiplications and additions in parallel on different data elements from operand buffers 132, 134 and a memory structure (e.g., tile state RAM 142) to store results from the ALUs, allowing accumulation of elements of the product matrix to occur across different operations. (The stored results are sometimes referred to herein as “tile state data,” for reasons that will become apparent.) Examples are described below. Cell array 140 has a finite size, and in cases where the size of the product matrix exceeds the dimensions of cell array 140, computation of the product matrix can proceed in stages, as described below, with in-progress state data being transferred in and out of the local memory structure. For instance, C operand buffer 136 can be used as temporary storage for in-progress state data that is being transferred to tile state RAM 142.

According to some embodiments, vector data is loaded into operand buffers 132, 134 in a row-wise manner and is delivered to cells of cell array 140 in a column-wise manner. As described below, this arrangement supports a natural ordering of matrix elements in memory while potentially increasing the arithmetic intensity (e.g., number of computations that can be completed per cycle) of matrix multiply engine 120.

Read queue 128 can receive rows or columns from the memory structure in cell array 140 and provide the received rows or columns to vector processor 110, where the data can be written back to vector register file 116 and/or provided to VSTORE queue 118 for storing into external memory.

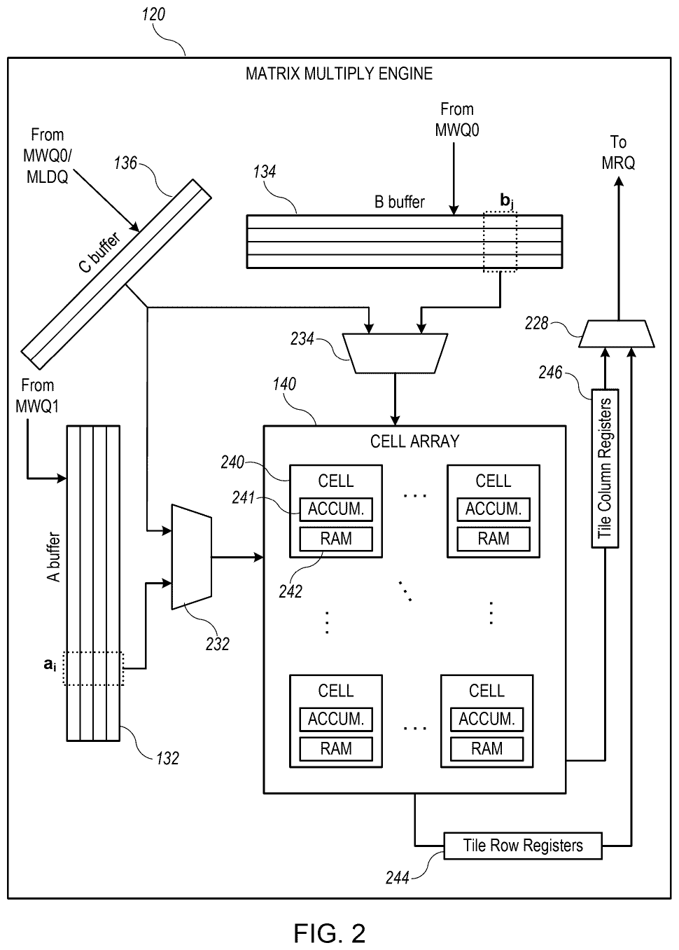

FIG. 2 shows a simplified block diagram illustrating additional features of matrix multiply engine 120 according to some embodiments. As described above, matrix multiply engine 120 can include a first operand buffer 132 (also referred to as an “A buffer”), a second operand buffer 134 (also referred to as a “B buffer”), and a third operand buffer 136 (also referred to as a “C buffer”). A buffer 132 and B buffer 134 each provide temporary storage for elements of the matrices A and B that are being multiplied. A buffer 132 and B buffer 134 can be arranged in rows. In some embodiments, the width of each row of A buffer 132 and B buffer 134 can be equal to the width VLEN of the vector register file 116. The number of rows in A buffer 132 and B buffer 134 can be selected as desired. As described below, having multiple rows in the operand buffer is advantageous, and the number of rows can be, e.g., 4, 8, or another number. Thus, elements of operand matrices A and B can be loaded into vectors in vector register file 116 and read into rows of A buffer 132 and B buffer 134. Where matrices are stored in system memory in row-major order, a contiguous block of matrix elements from a row can be loaded as a vector into vector register file 116 and delivered to A buffer 132 or B buffer 134 without reshaping or otherwise rearranging.

Cell array 140 includes a plurality of cells 240, each of which may be identically configured. Each cell 240 is assigned to compute a subset of elements cᵢⱼ of product matrix C during a matrix multiplication computation. For example, each cell 240 can be assigned to update a square subarray of adjacent elements cᵢⱼ (also referred to herein as “tile elements”). The size of the subarray can be characterized by a parameter TE_CELL, with the subarray including TE_CELL×TE_CELL elements cᵢⱼ. In various embodiments, TE_CELL can be 4 or 8 or another number, such as a higher power of 2. Each cell 240 can include tile state RAM 242 to store the elements of the subarray and accumulator logic 241 to read columns of data elements from A buffer 132 and B buffer 134, to compute a dot product of the data elements, and to add the dot product to a corresponding element in tile state RAM 142. In particular, for a first k-component column vector aᵢ (from A buffer 132) and a second k-component column vector bⱼ (from B buffer 134), accumulator logic 241 can include circuits that perform the computation cᵢⱼ+=aᵢ·bⱼ, with cᵢⱼ being read from and written back to a particular location in tile state RAM 242. Examples of circuits implementing cell 240 are described below. In some embodiments, a cell 240 can complete its operation over multiple cycles, updating a subset of the tile elements during each cycle.

Cell array 140 can include m rows and n columns of cells 240 that can operate in parallel, where the numbers m and n are fixed parameters of the hardware design. Accordingly, cell array 140 can collectively update a tile of dimensions TE_m×TE_n, where TE_m=m*TE_CELL and TE_n=n*TE_CELL. In examples herein, m=n and TE_m=TE_n=TE. For convenience m and n can be powers of 2. Selection of TE_CELL and TE (or m and n) can be based on tradeoffs of area versus throughput. For instance, if TE is 32 and TE_CELL is 4, then cell array 140 includes an 8×8 array of cells 240, while if TE is 64 and TE_CELL is 8, then cell array 140 includes a 16×16 array of cells 240. The latter configuration can provide higher throughput (by about a factor of 4) but also larger area (again, by about a factor of 4). Each cell 240 can be mapped to a particular position within a tile. Tile state RAM 142 can store multiple tiles, and in instances where product matrix C is larger than the dimensions of a tile, cells 240 can access different tiles within tile state RAM 142 using tile offset addressing.

FIG. 2 also illustrates readout of data from tile state RAM 142 according to some embodiments. Readout can be either column-based or row-based. For row-based readout, data read from tile state RAM 242 in cells 240 in a row of cell array 140 can be aggregated in tile row registers 244 and delivered via multiplexer 228 to read queue 128. For column-based readout, data read from tile state RAM 242 in cells 240 a column of cell array 140 can be aggregated in tile column registers 246 and delivered via multiplexer 228 to read queue 128. Multiplexer 228 allows column-based reads and row-based reads to proceed to read queue 128 along the same data path.

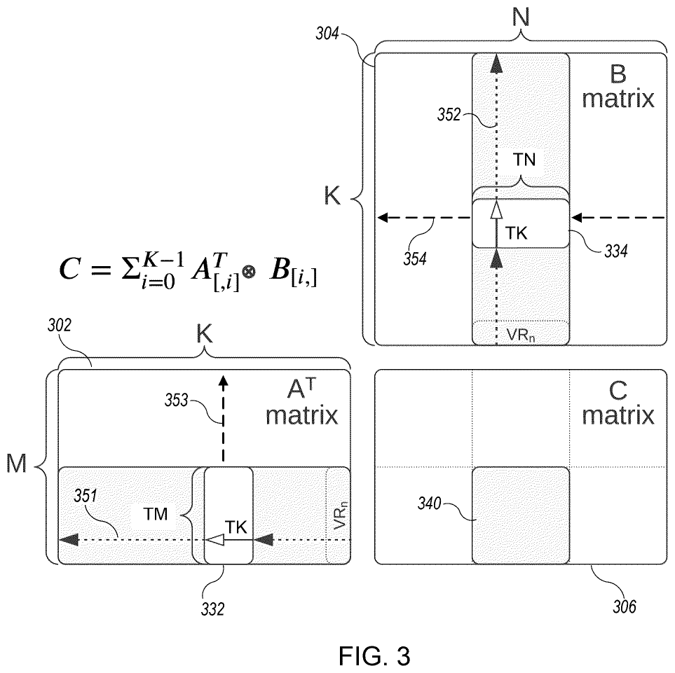

The dimensions of a matrix product that can be computed in a single pass through cell array 140 are limited by hardware to TE×TE. In principle, TE could be made as large as desired, e.g., by adding more cells 240; however, practical considerations such as chip area and size may impose an upper limit on TE. Accordingly, a product matrix having one or both dimensions larger than TE can be computed using multiple passes through cell array 140 and successive accumulations into particular elements cᵢⱼ. FIG. 3 illustrates an operating principle for multiplication of large matrices according to some embodiments. Operand matrices A^{T} (dimensions M×K) and B (dimensions K×N) and product matrix C (dimensions M× N) are represented as rectangles 302, 304, 306, respectively. In a given pass through cell array 140, a patch 332 within matrix A^{T} having width TM (which may correspond to the width of the vector registers) and “patch thickness” TK (constrained by the number of rows in operand buffers 132, 134) and a patch 334 within matrix B having patch thickness TK (equal to the patch thickness of patch 332 within matrix A^{T}) and height TN (which may also correspond to the width of the vector registers) are read into operand buffers 132, 134 and operated on by cells 240 in cell array 140 to compute updates for elements within a TM×TN tile 340 of product matrix C according to cᵢⱼ+=aᵢ·bⱼ, where patch thickness TK determines the dimension of vectors aᵢ and bⱼ. Patches 332 and 334 can be shifted for different passes through cell array 140 to cover the K dimension of matrices A^{T} and B, as suggested by dotted arrows 351, 352 and shifted in the orthogonal direction to cover the M and N dimensions of matrices A^{T} and B as suggested by dashed arrow 353, 354. It will be appreciated that different patches 332, 334 within operand matrices A^{T} and B can contribute to elements within the same tile 340 of product matrix C. It will also be appreciated that the matrix dimensions M, K, and N need not be integer multiples of patch dimensions TM, TK, and TN and that some patches can have smaller dimensions, e.g., at the edges of one or both operand matrices.

In some embodiments, tile state RAM 242 in a cell 240 can be large enough to store a subarray for each of multiple tiles 340. Even so, there may be instances where the size of product matrix C exceeds the number of tiles that can be stored using tile state RAM 242. Where this is the case, portions of matrix C can be swapped in and out of tile state RAM 242 as the computation progresses. For instance, as shown in FIG. 2, a row of elements can be read from tile state RAM 242 into tile row registers 244 and sent from tile row registers 244 registers 246 to read queue 128. As shown in FIG. 1, data received by read queue 128 can be written to system memory (not shown) via VSTORE queue 118. Externally-stored elements can be retrieved for use in additional accumulation passes. For instance, data stored in system memory can be read via VLOAD queue 114 into C buffer 136 and loaded into tile state RAM 242 from C buffer 136.

Binary code executed by a system such as processor system 100 can specify the sequence of computations for different patches of large input matrices. In some embodiments, the sequencing of computations and the arrangement of matrix elements can be made transparent to application developers. For instance, a compiler can be configured to receive code in a high-level computer language that includes a instruction to compute matrix product C=M1*M2. The compiler can generate an appropriate sequence of binary instructions executable by processor system 100 that enable matrix multiply engine 120 to operate sequentially on different regions of the operand matrices to complete the computation of the product. The instructions can include appropriate sequences of read, write, and execute instructions, examples of which are described below, and can include instructions that result in providing a transpose of matrix M1 in memory as well as instructions related to moving elements of tile state in and out of tile state RAM 242 in the case where the product matrix size exceeds the storage capacity of tile state RAM 242. The optimal binary instruction sequence can depend on operand width, the size of operand buffers 132, 134, the number of cells 240 in cell array 140, and other parameters. Those skilled in the art with the benefit of the present disclosure will be able to generate suitable compiler code.

In some embodiments, circuits implementing cells 240 can be designed such that patch thickness TK is a function of operand width. For narrower operands, TK can be increased up to a maximum value supported by the hardware. For wider operands, TK can be decreased. Widening the outer product for narrower operands and performing unit-stride operations along the M and N dimensions of the operand matrices can increase the arithmetic intensity of the matrix multiply engine, as compared to approaches that widen in the M and N dimensions as operand width decreases.

### Cell Circuit Examples

As described above, each cell 240 in matrix multiply engine 120 can include logic circuits that perform the computations to update portions of the tile state of the product matrix. A circuit implementing a cell 240 can be designed as an instantiable module, and multiple copies of the cell module can be included in a matrix multiply engine. Selection of the number of cells involves design tradeoffs that may include considerations of chip area and power versus processing speed.

In some embodiments, cells 240 can handle operands in various formats, with operand format being determined at runtime. For instance, operand element width (SEW) and tile element width (TEW) can be runtime parameters determined for a specific matrix multiplication operation. Depending on the operation, SEW and TEW can be the same or different; for instance, for integer formats it may be desirable for TEW to be wider than SEW. (A parameter WIDEN can be defined as TEW/SEW.) For instance, some embodiments may accommodate operand element and tile element widths of 8, 16, 32, or 64 bits. The behavior of cells and other components of the matrix multiply engine can be dynamically modified based on SEW and TEW for a particular matrix multiply operation. For instance, the patch thickness TK of a region within operand matrices A and B that is processed during a given pass through cell array 140 can be increased or decreased based on SEW and TEW. An upper limit on TK (referred to as KMAX) can be imposed by hardware, e.g., based on the maximum dimension of vectors for which a cell 240 can compute a dot product. KMAX may depend on the operand element width SEW.

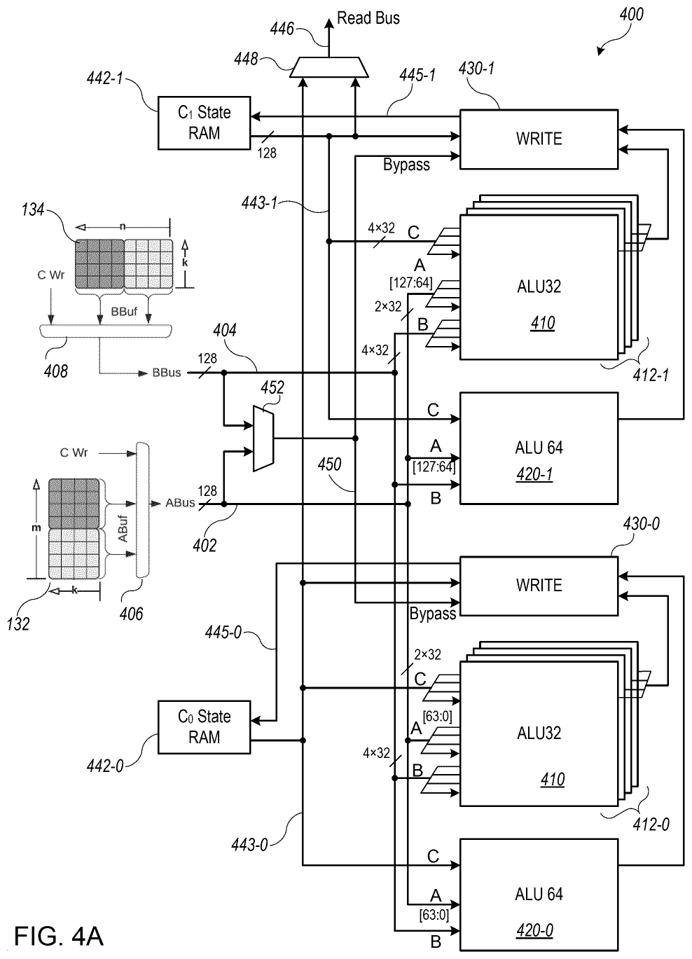

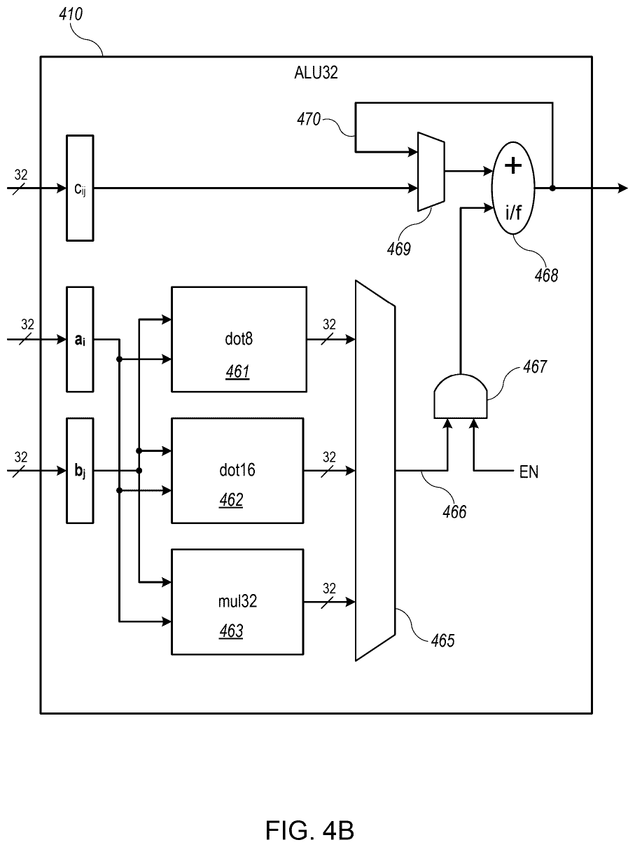

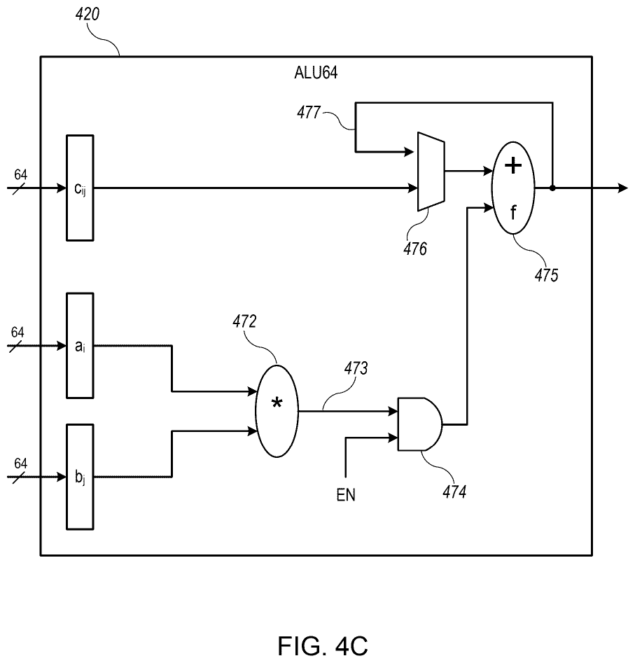

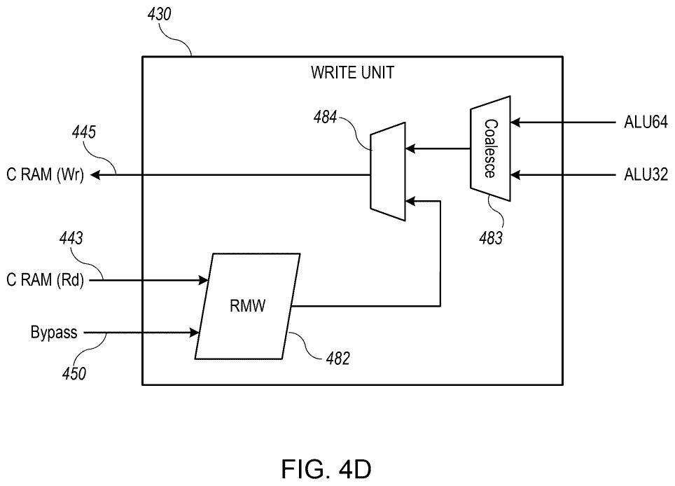

Cells capable of handling dynamic operand widths (SEW, TEW) and TK can be constructed using a variety of circuits and techniques. By way of example, FIGS. 4A-4D show simplified schematic diagrams of a circuit 400 that can be used to implement cell 240 in matrix multiply engine 120 of FIG. 1 according to some embodiments. Circuit 400 is optimized for SEW=TEW=32 but can also handle a smaller number of wider elements (e.g., SEW=TEW=64) with reduced throughput.

FIG. 4A shows a high-level diagram of circuit 400. Circuit 400 reads column-wise (in the directions indicated by arrow k) from A buffer 132 and B buffer 134 onto A bus 402 and B bus 404. Via multiplexers 406, 408, data can be delivered onto A bus 402 or B bus 404 from the corresponding operand buffer 132, 134 or from C buffer 136 (data from C buffer 136 is labeled as “C Wr” in FIG. 4A). The C Wr data paths can be used to store tile elements into tile state RAM 142 via a bypass path, as described below. In this example, each of A bus 402 and B bus 404 is 128 bits wide; different bus widths can be substituted.

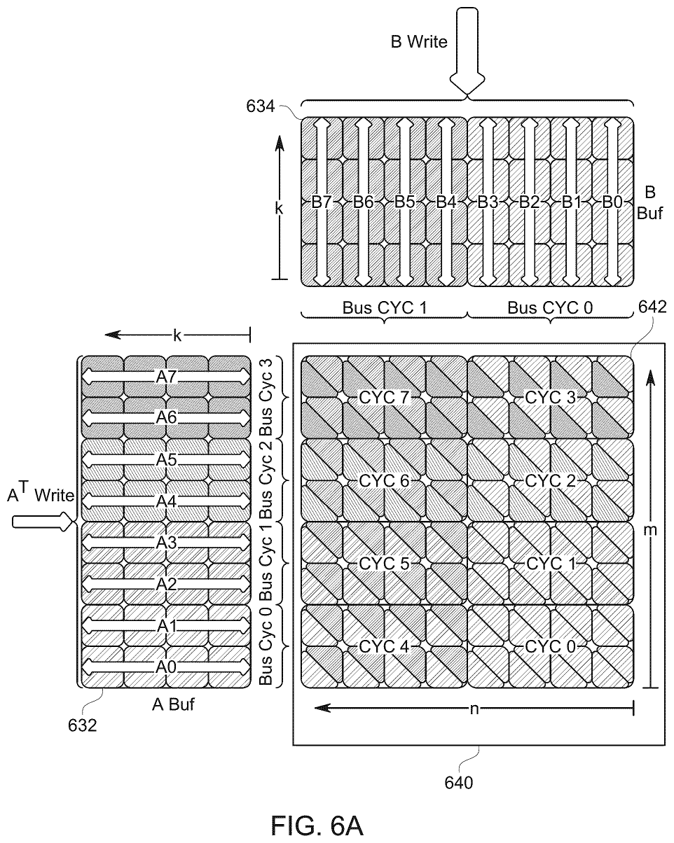

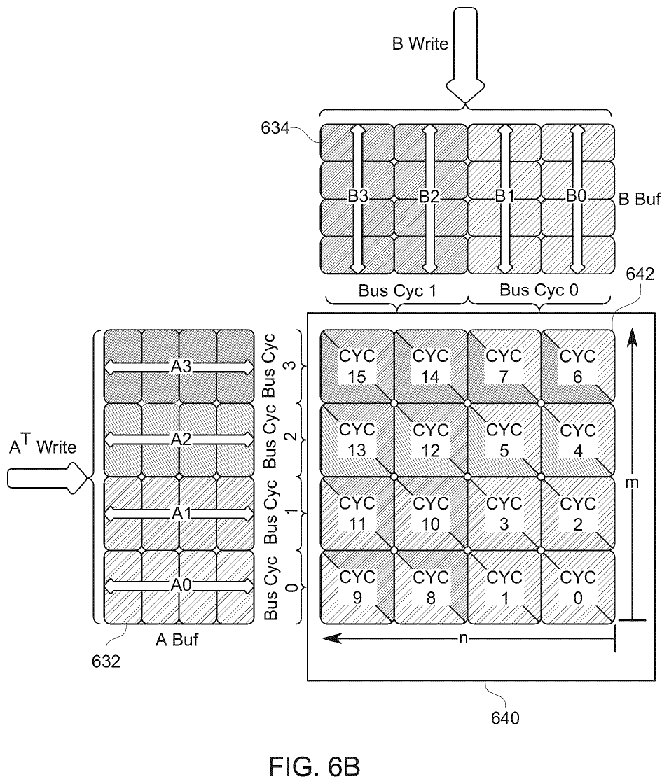

Circuit 400 includes ALU32 circuits 410. Each ALU32 circuit 410 can be configured to perform a multiply-add operation on inputs A, B, and C, where inputs A and B can be scalars or vectors, depending on the operand width. An example ALU32 circuit 410 is described below with reference to FIG. 6B. As shown in FIG. 4A, ALU32 circuits 410 can be arranged in two groups 412-0 and 412-1, each including four ALU circuits 410. This arrangement can support computation of multiple dot products during the same cycle, as described below. Data paths coupled to A bus 402 and B bus 404 can route elements of operand matrices A and B to different ALU circuits 410. For instance, the bits on A bus 402 that correspond to a first column vector a₀ can be delivered to each ALU32 circuit 400 in the first group 412-0, while the bits on the A bus that correspond to a second column vector a₁ can be delivered to each ALU circuit 410 in the second group 412-1. Bits on the B bus can be delivered to both groups 412-0, 412-1 such that each of the column vectors b₀ through b₃ is received by a different one of the ALU32 circuits 400 in each group 412-0, 412-1. Tile state data is stored in C0 state RAM 442-0 and C1 state RAM 442-1 (which can be, e.g., different banks in a single RAM circuit). Tile state data can be read from C0 state RAM 442-0 and C1 state RAM 442-1 and distributed to ALU32 circuits 410 via C0 data path 443-0 and C1 data path 443-1. Accordingly, ALU32 circuits 410 can compute a vector dot product of input vectors a; and b; (of dimension TK) and accumulate the result into a tile element cᵢⱼ, thereby producing an element of updated tile state. Depending on operand width, different numbers of tile elements can be updated per cycle.

Circuit 400 also includes two ALU64 circuits 420. Each ALU64 circuit 420 can be configured to perform a multiply-add operation on inputs A, B, and C, where inputs A and B are 64-bit scalars; the output is a 64-bit scalar. An example ALU64 circuit 410 is described below with reference to FIG. 4C. As shown in FIG. 4A, ALU64 circuits 420 can support computation of a total of two 64-bit products during the same cycle, as described below. Data paths coupled to A bus 402 and B bus 404 can route elements of operand matrices A and B to ALU64 circuits 420. For instance, the 64 bits on A bus 402 that correspond to a 1-dimensional column vector (i.e., a scalar) a₀ can be delivered to ALU64 circuit 420-0, while the bits on the A bus that correspond to 1-dimensional column vector a₁ can be delivered to ALU64 circuit 420-1. The 64 bits on the B bus can be delivered to both ALU64 circuits 420. Tile state data can be read from C0 state RAM circuit 442-0 and C1 state RAM circuit 442-1 and delivered to ALU64 circuits 420-0 and 420-1 via C0 data path 443 and C1 data path 444. Accordingly, ALU64 circuits 420 can each compute a product of one-dimensional input vectors (i.e., scalars) aⱼ and bⱼ and accumulate the result into the element cᵢⱼ, thereby producing an element of updated tile state.

Updated tile state values from ALU32 circuits 410 or ALU64 circuits 420 (depending on operand width) are provided to write units 430, with ALU32 circuits 410 in first group 412-0 and ALU64 circuit 420-0 providing values to write unit 430-0 while ALU32 circuits 410 in second group 412-1 and ALU64 circuit 420-1 provide values to write unit 430-1. Write units 430 handle selection of data to write back to C0 state RAM circuit 442-0 and C1 state RAM circuit 442-1 via writeback paths 445-0 and 445-1. An implementation of write unit 430 is described below with reference to FIG. 4D.

FIG. 4A also shows a bypass path 450 that can be used to deliver data directly to C0 state RAM circuit 442-0 and C1 state RAM circuit 442-1. Multiplexers 406, 408 can selectably output either operand data from A buffer 132 and B buffer 134 or stored tile state data that is retrieved from external memory (“C Wr” in FIG. 4A). As noted above, when large matrices are being multiplied, tile state data for some tiles may be stored externally to matrix multiply engine 120, and as the multiplication proceeds it may be desirable to move different tiles into and out of tile state RAM 242 (including C0 state RAM circuit 442-0 and C1 state RAM circuit 442-1). Moving a tile into tile state RAM 242 can include reading a tile from external memory into vector processor 110 of FIG. 1 (e.g., via VLOAD queue 114 and load queue 124) and providing the tile to C buffer 136. Accordingly, in some embodiments, C buffer 136 can be the source of “C Wr” data in FIG. 4A. As shown in FIG. 4A, multiplexer 452 can selectably direct data from A bus 402 or B bus 404 to bypass path 450, which couples into write units 430, enabling data to be written to C state RAM circuits 442 without passing through any ALU circuits.

FIG. 4A also shows a readout path for reading tile state from C0 state RAM 442-0 and C1 state RAM 442-1. A multiplexer 448 selectably provides data from C0 data path 443 or C1 data path 444 to a read bus 446. Read bus 446 can deliver the data to tile row registers 244 or tile column registers 246, as shown in FIG. 2.

FIG. 4B shows a more detailed schematic diagram of an ALU32 circuit 410 according to some embodiments. Circuit 410 receives 32-bit operands aᵢ and bⱼ, which can be four-component column vectors in the case where SEW=8, two-component column vectors in the case where SEW=16, or one-component column vectors (i.e., scalars) in the case where SEW=32 Operands a; and b; can be routed to a first dot-product (dot8) circuit 461, a second dot-product (dot16) circuit 462, and a multiplier (mul32) circuit 463. Dot8 circuit 461 can include multiplier and adder circuits (not shown) configured to compute a dot product of two four-component vectors, where each vector component has SEW=8. For example, dot8 circuit 461 can include four 8-bit×8-bit multiplier circuits, each multiplying a different pair of components of operands aᵢ and bⱼ, and adder circuits arranged to sum the outputs of the multiplier circuits, producing a 32-bit output via fused multiply-add. Similarly, dot16 circuit 462 can include multiplier and adder circuits (not shown) configured to compute a dot product of two two-component vectors, where each vector component has SEW=16. For example, dot16 circuit 462 can include two 16-bit×16-bit multiplier circuits, each multiplying a different pair of components of operands aᵢ and bⱼ, and an adder circuit arranged to sum the outputs of the multiplier circuits, producing a 32-bit output via fused multiply-add. In some embodiments, each of dot8 circuit 461 and dot 16 circuit 462 can support both integer and floating-point operand formats. Mul32 circuit 463 can include one 32-bit×32-bit floating-point multiplier circuit that computes the scalar product aᵢ*bⱼ and produces a 32-bit floating-point result.

For any given operating cycle, the operands have a particular (known) format; accordingly, in any given cycle, only one of dot8 circuit 461, dot16 circuit 462, or mul32 circuit 463 produces a valid result. (In some embodiments, one circuit can be selectively enabled based on operand formats.) Multiplexer 465 selects the valid result onto data path 466.

Adder circuit 468 can be a 32-bit adder circuit capable of operating on inputs in integer and floating-point formats. Adder circuit 468 receives the (scalar) product of operands aᵢ and bⱼ via data path 466 as one input. In some embodiments, an enable gate 467 can be provided on data path 466 to allow the scalar product output to be ignored if desired (e.g., during power management operations or where the operands are 64 bits). Adder circuit 468 also receives, as the other input, scalar operand cᵢⱼ (the tile element being updated) from tile state RAM 442. Thus, adder circuit 468 can accumulate the scalar product aᵢ·bⱼ with the existing tile element cᵢⱼ. In some embodiments, multiplexer 469 and bypass path 470 can support successive accumulations into the same tile element cy without needing to write back to tile state RAM 442. Bypass path 470 can improve performance for small matrices in which successive operations may be performed on the same tile. The output of adder 468 can be delivered to write unit 430 as shown in FIG. 4A.

In some embodiments, ALU32 circuit 410 can support different rounding modes for at least some operand widths at both the dot-product and accumulation stages, and a particular rounding mode can be specified at runtime.

FIG. 4C shows a more detailed schematic diagram of an ALU64 circuit 420 according to some embodiments. Circuit 420 receives 64-bit operands aᵢ and bⱼ, which can be one-component column vectors (i.e., scalars). Circuit 420 includes a multiplier circuit 472 configured to multiply two 64-bit floating-point operands and produce a 64-bit floating-point output on data path 473.

Adder circuit 475 can be a 64-bit adder circuit capable of operating on floating-point inputs. Adder circuit 475 receives the product aᵢ·bⱼ via data path 473 (which can include an enable gate 474) as one input. Adder circuit 475 also receives, as its other input, tile element cᵢⱼ from tile state RAM 442. Thus, adder circuit 475 can accumulate the scalar product aᵢ·bⱼ with the existing tile element cᵢⱼ. In some embodiments, multiplexer 476 and bypass path 477 can support successive accumulations into the same tile element without needing to write back to tile state RAM 442. The output of adder 475 can be delivered to write unit 430 as shown in FIG. 4A.

FIG. 4D shows a more detailed schematic diagram of a write unit 430 according to some embodiments. As shown in FIG. 4A, write unit 430 receives inputs from tile state RAM 442 (via data path 443) and from bypass data path 450. Write unit 430 also receives inputs from a group of ALU32 circuits 410 and from an ALU64 circuit 420. As shown in FIG. 4D, write unit 430 can include a read-modify-write (RMW) circuit 482, a coalescing multiplexer 483, and a selection multiplexer 484. RMW circuit 482 handles input of data from bypass path 450 into tile state RAM 442, including instances where only a portion of a tile is being updated. Coalescing multiplexer 483 can allow compression of write operations to different tile elements cᵢⱼ. Selection multiplexer 484 selects either the bypass data or the updated state output from the ALUs to be written back to tile state RAM 442 via data path 445.

Circuit 400 advantageously enables the dimension of the column vectors aᵢ and bⱼ (which corresponds to patch thickness TK in FIG. 3) to scale inversely with operand width (i.e., as operand width increases, TK decreases). Those skilled in the art with access to this disclosure will appreciate that other implementations of cells that support scaling of patch thickness TK with operand width are possible, and that various implementations can support different combinations of operand formats. In some embodiments, performance of circuit 400 can be optimized for a particular tile element width (e.g., TEW=32), while increasing TK to provide satisfactory performance for narrower elements. The number of tile elements per cell can be increased or decreased, e.g., by modifying the number of instances of ALUs.

### Cell Operation Examples

According to some embodiments, a cell in a matrix multiply engine can use one or more clock cycles to compute one or more elements of a tile. The elements computed by a cell can constitute a “subarray” within the tile. For instance, a cell implemented using circuit 400 can compute a square subarray of a tile over two or more bus cycles. The particular dimensions of the subarray assigned to each cell and the number of cycles required to compute the subarray can be determined at run time, based on operand width SEW and tile element width TEW. The maximum linear dimension of a subarray assigned to a cell can be defined as a parameter TE_CELL. (The subarray can have dimensions TE_CELL×TE_CELL.)

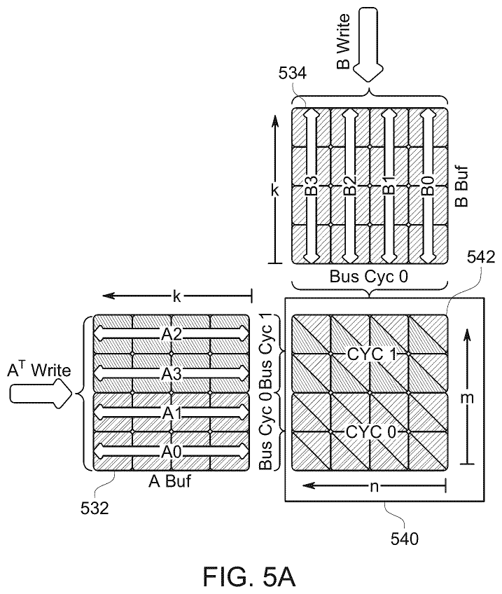

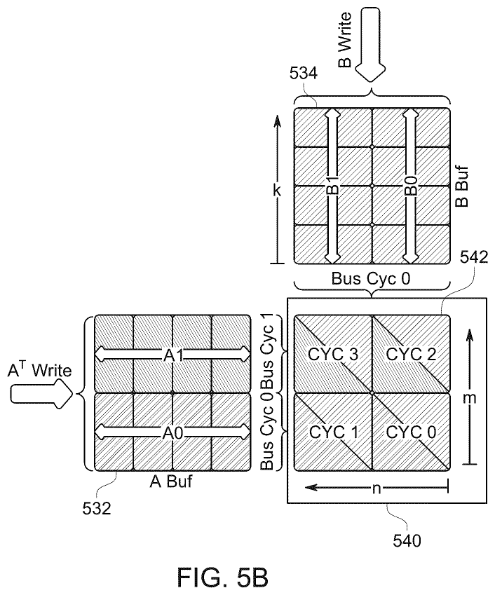

FIGS. 5A and 5B illustrate an operating principle for a cell 540 in a matrix multiply engine according to some embodiments. For cell 540, TE_CELL=4. In FIG. 5A, the operands have width SEW=8 while tile elements in subarray 542 have width TEW=32. In this case, TK=4. Shown in FIG. 5A are a portion of an operand A buffer 532, a portion of an operand B buffer 534, and a cell 540 (which can be, e.g., implemented using circuit 400 described above). Cell 540 updates a 4×4 subarray 542 of tile state in two cycles. During a first bus cycle (“Bus Cycle 0” in FIG. 5A), cell 540 reads two four-component column vectors a₀, a₁ from A buffer 532 and four four-component column vectors b₀ through b₃ from B buffer 534. Using these inputs, cell 540 can compute a first set of eight dot products aᵢ·bⱼ (i=0,1; j=0,1,2,3) and accumulate the dot products into corresponding elements (labeled “CYC 0”) in subarray 542. During a second bus cycle (“Bus Cycle 1” in FIG. 5A), cell 540 reads two more column vectors a₂, a₃ from A buffer 532. Using these inputs, cell 540 can compute a second set of eight dot products aᵢ·bⱼ (i=2,3; j=0,1,2,3) and accumulate the dot products into corresponding elements (labeled “CYC 1”) in subarray 542.

In FIG. 5B, SEW=TEW=64. In this case, TK=1, and cell 540 updates a 2×2 subarray 542 of a tile in four cycles. During a first bus cycle (“Bus Cycle 0” in FIG. 5B), cell 540 reads one column vector a₀ from A buffer 532 and two column vectors b₀, b₁ from B buffer 534. In this case, due to the operand width, TK=1 and each column vector is a one-dimensional vector (or scalar). Using these inputs, cell 540 computes one scalar product per cycle (product a₀·b₀ during a first cycle and product a₀·b₁ during a second cycle) and accumulates the products into corresponding elements (labeled “CYC 0” and “CYC 1”) in subarray 542. Similarly, during a second bus cycle (“Bus Cycle 1” in FIG. 5B), cell 540 reads one (single-element) column vector a₁ from A buffer 532. Using these inputs, cell 540 computes one scalar product per cycle (product a₁·b₀ during a third cycle and product a₁·b₁ during a fourth cycle) and accumulates the products into corresponding elements (labeled “CYC 2” and “CYC 3”) in subarray 542.

Additional examples are illustrated in FIGS. 6A and 6B for a cell 640 having TE_CELL=8. In FIG. 6A, SEW=8, TEW=32, and TK=4. During a first bus cycle (“Bus Cycle 0” in FIG. 6A), cell 640 reads two four-component column vectors a₀, a₁ from A buffer 632 and four four-component column vectors b₀ through b₃ from B buffer 634. Using these inputs, cell 640 can compute a first set of eight dot products aᵢ·bⱼ (i=0,1; j=0,1,2,3) and accumulate the dot products into corresponding elements (labeled “CYC 0”) in subarray 642. During a second bus cycle (“Bus Cycle 1” in FIG. XIA), cell 640 reads two more column vectors a₂, a₃ from A buffer 632. Using these inputs, cell 640 can compute a second set of eight dot products aᵢ·bⱼ (i=2,3; j=0,1,2,3) and accumulate the dot products into corresponding elements (labeled “CYC 1”) in subarray 642. Continuing in this manner for two additional cycles, cell 640 accumulates dot products into elements labeled “CYC 2” and “CYC 3” in subarray 642. During a fifth cycle, cell 640 switches to reading column vectors b₄ through b₇ from B buffer 634 and again reads two column vectors a₀, a₁ from A buffer 632. Thus during the fifth cycle, cell 640 can compute a fifth set of eight dot products aᵢ·bⱼ (i=0,1; j=4,5,6,7) and accumulate the dot products into corresponding elements (labeled “CYC 4”) in subarray 642. Three more cycles following the same read pattern complete the accumulation into elements labeled “CYC 5,” “CYC 6,” and “CYC 7.”

In FIG. 6B, SEW=TEW=64. In this case, TK=1, and cell 640 updates a 4×4 subarray 642 of a tile in sixteen cycles. Similarly to the relationship between FIGS. 5A and 5B, in FIG. 6B the number of column vectors read per bus cycle is halved relative to FIG. 6A, and TK (the patch thickness, or dimension of the column vectors) is also reduced from 4 to 1. Cell 640 computes sixteen scalar products and accumulates into sixteen elements of subarray 642 in sixteen cycles.

It should be understood that FIGS. 5A-6B are illustrative of cells in a matrix multiply engine that is run-time configurable to handle operands of different widths. In these examples, it is assumed that the widest operands are 64 bits and that the computation should be distributed across the cells of the cell array to maximize parallelism. One advantage of allowing run-time configuration is that for large operands, all cells in the cell array have work to do, while for smaller operands, overall computation time can be decreased by increasing the patch thickness TK. As can be seen by comparing FIGS. 5A and 5B or FIGS. 6A and 6B, allowing TK to increase for smaller operand widths increases the number of tile elements that can be accumulated in a single clock cycle: when TK=4, the cell accumulates eight elements per clock cycle, as compared to one element per clock cycle when TK=1. For algorithms that rely heavily on matrix multiplication (such as neural network algorithms) and that can yield satisfactory results with smaller operand widths, the speedup realized using cell circuitry of the kind described herein can be substantial. Enabling cells to accumulate more elements per clock can produce acceleration comparable to increasing the number of cells, but with lower cost in terms of circuit area.

While the examples described above assume that SEW is at least 8, it will be appreciated that narrower operands, e.g., SEW=4 can be supported, e.g., using packed operands and suitable instructions to indicate whether an 8-bit operand should be treated as two 4-bit operands.

### Operand Buffer Examples

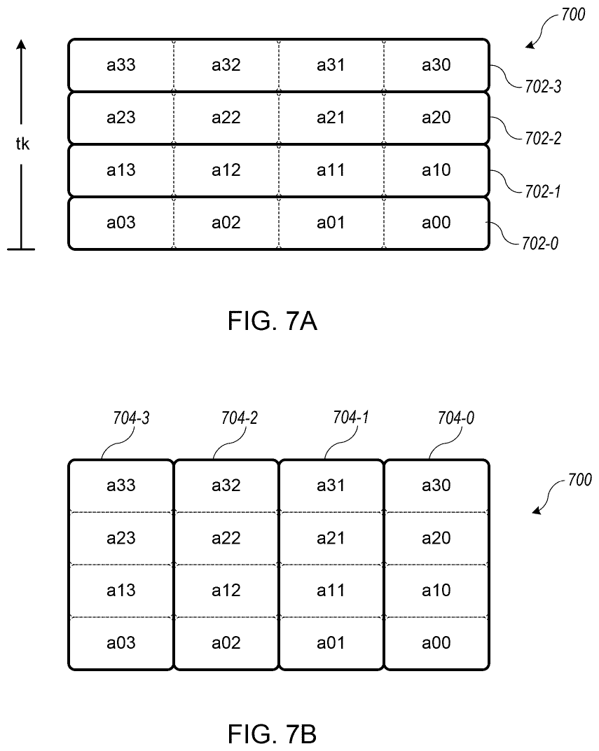

As described above, elements of the operand matrices can be written row-wise into A buffer 132 and B buffer 134 and read column-wise into cells 240. FIGS. 7A and 7B illustrate writing and reading for A buffer 132 according to some embodiments. In this example, A buffer 132 holds elements aᵢⱼ of operand matrix A for 0≤i≤3, 0≤j≤3. As shown in FIG. 7A, row 702-0 contains elements a₀ⱼ; row 702-1 contains elements a₁ⱼ; and so on. Rows 702-0 through 702-3 can be filled by successively writing rows of matrix A into A buffer 132. Where matrices are stored in memory in row-major order, row-wise reading into buffer 132 allows straightforward data paths into buffer 132 from system memory and/or vector register file 116.

In this example, the mapping of rows of matrix A to rows of A buffer 132 is one-to-one. As shown in examples described below, this need not be the case; for instance, a group of elements from one row of matrix A may occupy multiple rows of A buffer 132. It should also be understood that the number of elements per row of A buffer 132 depends on the width of a row and the width (SEW) of each element of matrix A.

FIG. 7B shows column-wise reads from A buffer 132 by a cell 240 in cell array 140: cell 240 can read elements aᵢ₀ in column 704-0 as a column vector a₀, elements aᵢ₁ in column 704-1 as a column vector a₁, and so on. It will be appreciated that row-wise writing and column-wise reading of the operand buffers meshes with the computation operations in cells 240 as described above.

The pattern of row-wise loading and column-wise reading can apply to both A buffer 132 and B buffer 134, with the result that matrix multiply engine 120 computes C=A^{T}*B (since the columns of matrix A are the rows of matrix transpose A^{T}). As noted above, if an application program being executed includes a high-level instruction to compute C=M1*M2 for matrices M1 and M2, the binary compiled code can insert instructions to transpose M1 prior to executing the matrix multiplication using matrix multiply engine 120 (e.g., by using the circuits and data paths described above to write elements of M1 into tile state RAM 242 column-wise, then read them row-wise). Matrix multiply engine 120 can then compute C=(M1^{T})^{T}*M2=M1*M2.

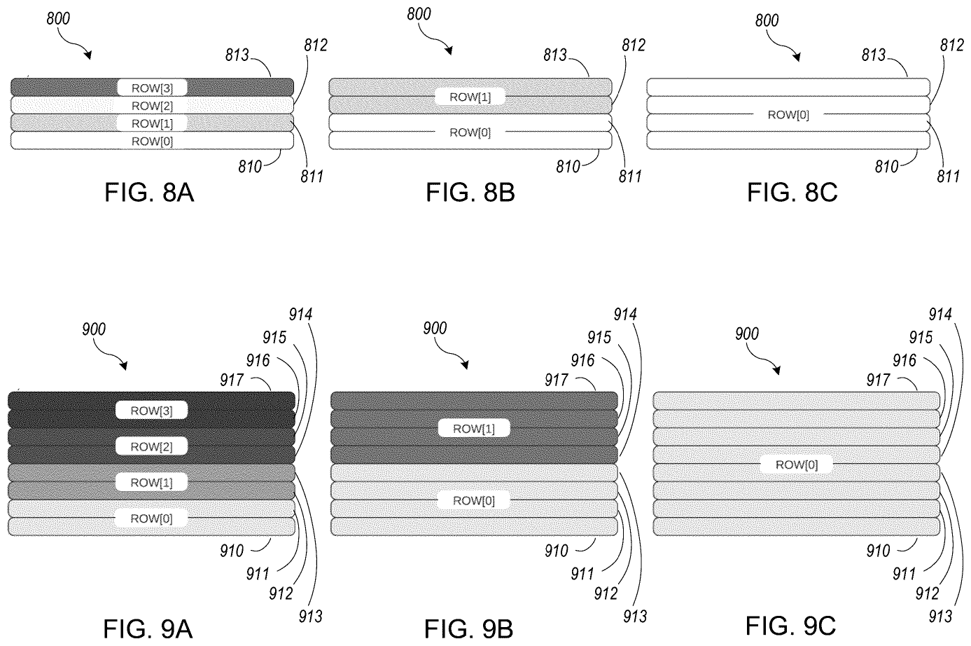

In some embodiments, operand matrix elements can be arranged in a vector register file (e.g., vector register file 116 of FIG. 1) in a manner that facilitates transfer of operand matrix elements from memory into the vector register file and from the vector register file to the operand buffers. For example, operand matrix elements can be loaded into a group of adjacent vector registers in the vector register file, where a group can consist of a fixed number of adjacent vector registers, such as four or eight vector registers. (It should be understood that the vector register file can accommodate multiple groups.) Rows of the operand matrix can be assigned to particular vector registers within in the group. FIGS. 8A-8C show examples of arranging operand matrix elements in a vector register group 800 (which can be, e.g., a portion of vector register file 116 of FIG. 1) depending on operand width SEW. In these examples, TE is less than VLEN/4, and vector register group 800 includes four vector registers 810-813. FIG. 8A shows an example of using vector register group 800 to store matrix elements having SEW=8 bits. Each vector register 810-813 stores elements from a different row of the operand matrix (indicated by labels ROW[0] through ROW[3] and corresponding shading), and TK=4 (since vector register file 800 has four vectors). FIG. 8B shows an example of using vector register group 800 to store matrix elements having SEW=16 bits. Vector registers 810 and 811 store elements from one row of the operand matrix (indicated by label ROW[0]), and vector registers 812 and 813 store elements from the next row (indicated by label ROW[1]). TK is reduced to 2. FIG. 8C shows an example of using vector register group 800 to store matrix elements having SEW=32 or 64 bits. In this example, all four vector registers 810 through 813 store elements from the same row of the operand matrix (indicated by label ROW[0]), and TK is reduced to 1.

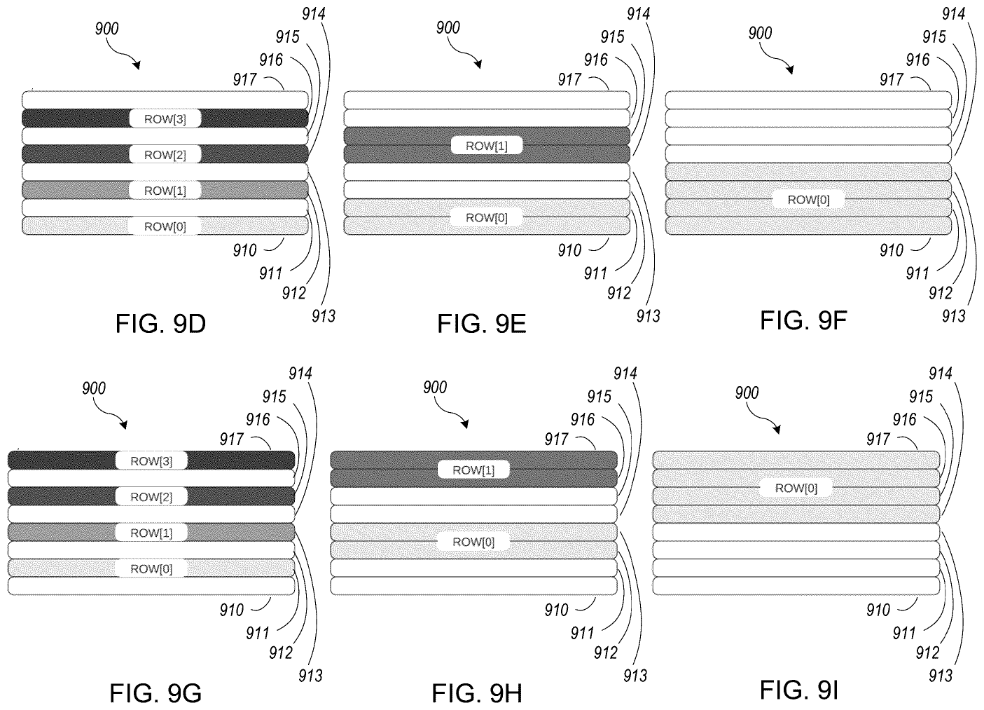

FIGS. 9A-9I show additional examples of arranging operand matrix elements in an vector register group 900 (which can be, e.g., a portion of vector register file 116 of FIG. 1) depending on operand width SEW. In these examples, vector register group 900 includes eight vector registers 910-917. In the examples of FIGS. 9A-9C, TE is equal to VLEN/4. FIG. 9A shows an example of using vector register group 900 to store matrix elements having SEW=8 bits. In this instance, TK=4. Vector registers 910 and 911 store elements from one row of the operand matrix (indicated by label ROW[0]); vector registers 912 and 913 store elements from the next row of the operand matrix (indicated by label ROW[1]); and so on. FIG. 9B shows an example of using vector register group 900 to store matrix elements having SEW=16 bits, where TK is reduced to 2. Vector registers 910-913 store elements from one row of the operand matrix (indicated by label ROW[0]), and vector registers 914-917 store elements from the next row (indicated by label ROW[1]). FIG. 9C shows an example of using vector register group 900 to store matrix elements having SEW=32 or 64 bits, where TK is reduced to 1. In this example, all eight vector registers 910-917 store elements from the same row of the operand matrix (indicated by label ROW[0]).

FIGS. 9D-9I show additional examples of arranging operand matrix elements in vector register group 900 when TE is less than VLEN/4. In these examples, successive rows of matrix elements are separated by 8/KMAX vector registers. FIGS. 9D-9F represent a “half-low” arrangement, while FIGS. 9G-9I represent a “half-high” arrangement. FIGS. 9D and 9G show examples of using vector register group 900 to store matrix elements having SEW=8 bits. In this instance, TK=4 and 8/KMAX is 2, so elements from successive rows of the operand matrix are stored in alternating vector registers of vector register group 900. In the half-low arrangement of FIG. 9D, “even” vector registers 910, 912, 914, 916 store elements from four rows of the operand matrix (indicated by labels ROW[0] through ROW[3]); “odd” vector registers 911, 913, 915, 917 are skipped. In the half-high arrangement of FIG. 9G, “odd” vector registers 911, 913, 915, 917 store elements from four rows of the operand matrix (indicated by label ROW[0] through ROW[3]); “even” vector registers 910, 912, 914, 916 are skipped. FIGS. 9E and 9H show examples of using vector register group 900 to store matrix elements having SEW=16 bits. In this instance, TK=2 and 8/KMAX is 4; elements from a given row of the operand matrix occupy a pair of adjacent vector registers in vector register group 900, and the next pair of adjacent vector registers in vector register group 900 is skipped. In the half-low arrangement of FIG. 9E, vector registers 910 and 911 store elements from one row of the operand matrix (indicated by label ROW[0]), and vector registers 914 and 915 store elements from the next row of the operand matrix (indicated by label ROW[1]); vector registers 912, 913 and 916, 917 are skipped. In the half-high arrangement of FIG. 9H, vector registers 912 and 913 store elements from one row of the operand matrix (indicated by label ROW[0]), and vector registers 916 and 917 store elements from the next row of the operand matrix (indicated by label ROW[1]); vector registers 910, 911 and 914, 915 are skipped. FIGS. 9F and 9I show examples of using vector register group 900 to store matrix elements having SEW=32 or 64 bits. In this instance, TK=1 and 8/KMAX is 8, so elements from adjacent rows of the operand matrix are stored in four contiguous vector registers of vector register group 900, with four vector registers being skipped between adjacent rows. In the half-low arrangement of FIG. 9F, vector registers 910-913 store elements from one row of the operand matrix (indicated by label ROW[0]), while vector registers 914-917 are skipped. In the half-high arrangement of FIG. 9I, vector registers 914-917 store elements from one row of the operand matrix (indicated by label ROW[0]), while vector registers 910-913 are skipped.

These examples of arranging elements of operand matrices in a vector register group are illustrative and can be modified. The same arrangement can be applied to both the A and B operand matrices. The arrangements illustrated allow rows of the vector register file to be transferred directly to the operand buffers without rearrangement of elements. For instance, the length of each row in each of operand buffers 132, 134 can be equal to the length of a vector register in vector register file 116, allowing a vector register to be transferred directly to a row in an operand buffer. In some embodiments, these arrangements also enable use of existing vector-stride unit loads to be used to load rows of input into a vector register file from a matrix stored in memory in row-major format, again without rearrangement of elements. In some embodiments, skipping of certain vector registers (e.g., as illustrated in FIGS. 9D-9I) can facilitate writing code that is agnostic to the number of vector registers being used to store operands from a given row. In other embodiments (e.g., as shown in FIGS. 8A-8C), vector registers need not be skipped regardless of SEW or other parameters.

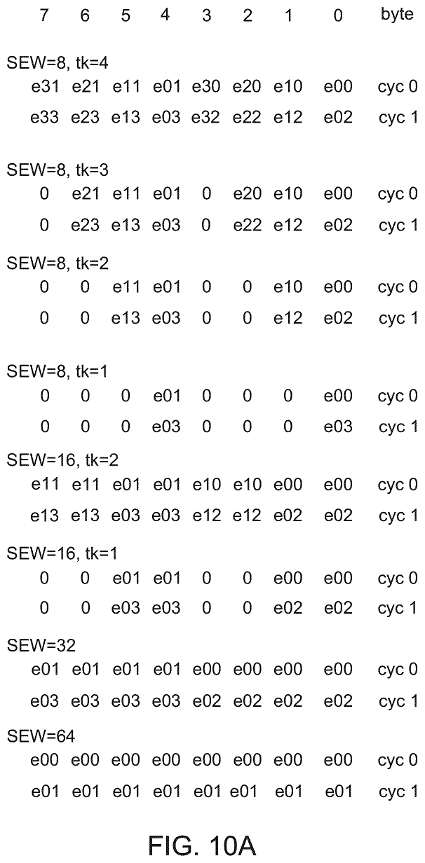

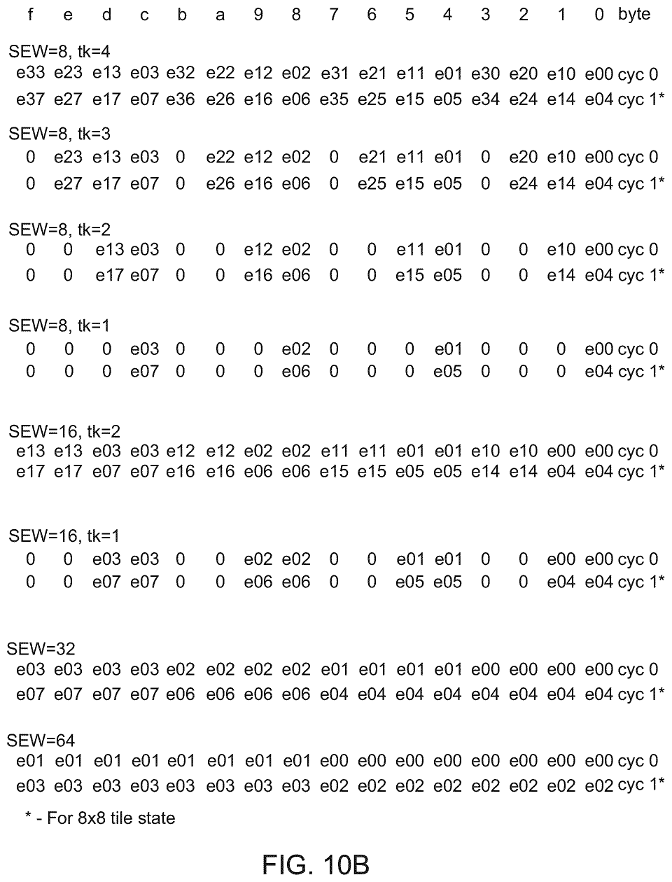

In some embodiments, a data bus between operand buffers 132, 134 and a cell 240 (e.g., A bus 402 or B bus 404 shown in FIG. 4A) can be wide enough to support transporting the operands needed for any supported combination of SEW and TK over either one or two bus cycles. FIGS. 10A and 10B show examples of element arrangements on a vector interface bus (e.g., A bus 402 or B bus 404 of FIG. 2A) according to some embodiments. For different combinations of operand element width SEW and patch thickness TK, FIG. 10A shows examples for a 64-bit vector buffer interface bus and FIG. 10B for a 128-bit vector buffer interface bus. Byte positions on the data bus are represented as columns, and the notation e ##denotes a position of the matrix element within the region (first digit refers to row, second digit refers to column). As shown, elements in adjacent rows and the same column occupy adjacent byte positions. Zeroes appear in instances where TK<KMAX (that is, where the patch thickness TK as shown in FIG. 3 is less than the maximum patch thickness KMAX for a given operand element width, which can occur for patches at the edges of an operand matrix). It should be noted that the zeroes can be inserted by the hardware so that a programmer does not need to think about the matrix format or the data bus width. In the case of a 128-bit interface, all elements can be read in one bus cycle if TE=4; two cycles are used if TE=8.

In some embodiments, the optimum arrangement of operand matrix elements in vector register file 116 depends on runtime parameters such as the matrix size (dimensions M and N as shown in FIG. 3) and operand size (SEW), as well as fixed attributes of the hardware. Accordingly, some embodiments of an instruction set architecture for a matrix multiply engine can include an instruction that computes and sets various parameters in control and status registers for the matrix multiply engine for a particular matrix product computation. In some embodiments, parameters that can be computed and set include tile dimensions (shown in FIG. 3 as TM, TN, and KMAX, which is the maximum value of TK for a particular operation), as well as a parameter “LMUL” that is used to allow multiple vector registers to be treated as a single longer vector register of length VLEN*LMUL, where VLEN is the hardware-defined length of a vector register in bits. (LMUL is a parameter used in the RISC-V vector extension.) LMUL indicates the number of vector registers that are included in the unit. Assuming that the length of a row in operand buffers 132, 134 in matrix multiply engine 120 is equal to VLEN, LMUL=1 is a configuration where each vector register (or each row of operand buffers 132, 134) holds elements from a different row of the corresponding operand matrix (e.g., as shown in FIG. 8A); LMUL=2 indicates that a pair of adjacent vector registers (or pair of rows of operand buffers 132, 134) holds elements from a single row of the corresponding operand matrix (e.g., as shown in FIG. 8B); and LMUL=4 indicates that four adjacent vector registers (or four rows of operand buffers 132, 134) hold elements from a single row of the corresponding operand matrix (e.g., as shown in FIG. 8C).

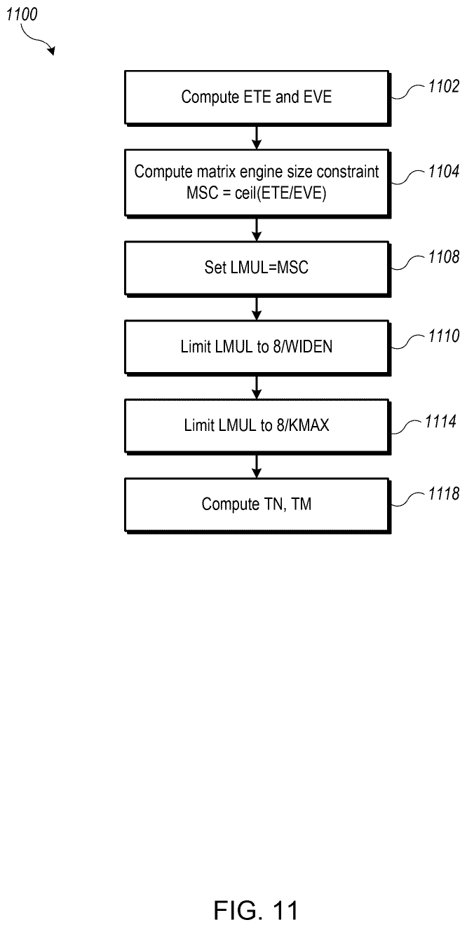

FIG. 11 shows a flow diagram of a process 1100 for determining LMUL for a matrix multiply operation according to some embodiments. Process 1100 can be implemented as an instruction executable in a processor (such as a scalar or vector processor) that controls matrix multiply engine 120. Process 1100 assumes that the following quantities have been established: (1) TE, the number of tile elements along an edge of a tile; (2) VLEN, the length of a vector register; (3) ATM and ATN, the M and N dimensions of the product matrix; (4) SEW, the width (in bits) of the elements of the operand matrices; (5) WIDEN, the ratio of tile element width (TEW) to SEW; and (6) KMAX, the maximum value of TK supported by the hardware for a given combination of SEW and TEW. Parameters TE, VLEN, and KMAX are fixed in the hardware design. Parameters ATM, ATN, SEW, and WIDEN are application-specific parameters determined at runtime.

At block 1102, auxiliary parameters ETE (effective number of tile elements along the tile edge) and EVE (effective number of vector elements in a vector register) are computed. For instance, ETE can be set to TE if TEW is less than 64 and to TE/2 if TEW is 64. (In some embodiments, SEW and WIDEN are provided, and TEW is computed as the product of SEW and WIDEN then used to determine ETE) EVE can be computed as VLEN/SEW. (Where VLEN and SEW are powers of 2, EVE is an integer.) At block 1104, a matrix engine size constraint (MSC) can be computed, e.g., using the function MSC=ceil (ETE/EVE), where ceil( ) is the standard ceiling function.

At block 1108, MSC can be adopted as an initial value for LMUL, which can be subject to various constraints that may reduce (but not increase) LMUL. For instance, at block 1110, LMUL can be constrained to not exceed 8/WIDEN, to ensure that a matrix row/column fits in the largest vector register group. At block 1114, LMUL can be further constrained to not exceed 8/KMAX. At block 1116, a ceiling function can be applied to constrain LMUL to being an integer, since fractional LMUL provides no benefit in the context of matrix multiply engine 120.

Process 1100 can also compute other parameters, including the patch dimensions TN, TM, and TK (as shown in FIG. 3), and TK. For instance, at block 1118, TN can be set to the minimum of ATN, LMUL*EVE (the number of elements in a group of vector registers defined by LMUL), or ETE (the effective number of tile elements along the tile edge). In some embodiments, TN can be set to the minimum of AVL, LMUL*EVE, or ETE, where AVL is an application-specific vector length determined at runtime (e.g., as defined in the RISC-V vector extension). Similarly, TM can be set to the minimum of ATM (the matrix dimension), LMUL*EVE (the number of elements in a group of vector registers defined by LMUL), or ETE (the effective number of tile elements along the tile edge). TK can be set to the minimum of ATK and KMAX, where ATK is an application-specific value of ATK determined at runtime. (That is, a software developer can specify a desired value of TK, which can be reduced if needed for a particular hardware implementation.)

The effect of process 1100 is to maximize the number of elements of product matrix C whose state can be updated per cycle of matrix multiply engine 120 for a given operation.

### Tile State Memory Examples

Referring again to FIG. 2, matrix elements cy updated by cells 240 can be stored in tile state RAM 242. The matrix elements updated by a particular cell 240 can correspond to a subarray of TE_CELL×TE_CELL elements at the same relative position within each tile of a large product matrix C (e.g., tile 340 as shown in FIG. 3). In some embodiments, tile-based addressing can be used to arrange matrix elements within tile state RAM 242. That is, the address for a particular element cᵢⱼ can be defined based on a tile number, the tile-relative row and column offsets of the element cᵢⱼ, and the tile element width (TEW), which determines the number of bytes needed to store each tile.

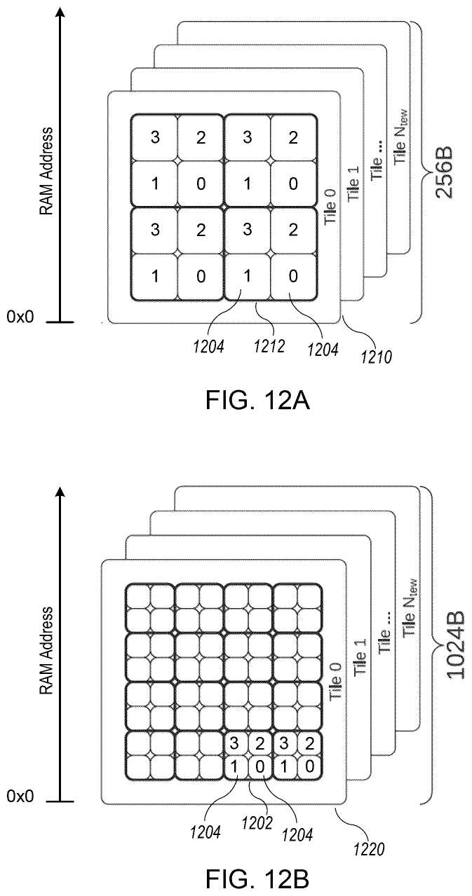

FIGS. 12A and 12B show examples of tile-based addressing in tile state RAM 242 for a cell 240 according to some embodiments. FIG. 12A shows an arrangement where cell 240 computes a 4×4 subarray 1210 of elements 1214 within each tile of the product matrix. The address pattern can be based on a 2×2 group 1212 of elements 1214 within subarray 1210. Addresses “0” through “3” in each element 1214 represent address offsets within group 1212. Additional subarrays 1210 for multiple tiles (Tile 0, Tile 1, . . . ) can be stored at successively higher addresses (e.g., the first element in the second tile can be located at the next address after the last element of the first tile). Similarly, FIG. 12B shows an arrangement where cell 240 computes an 8×8 subarray 1220 of elements 1214 within each tile of the product matrix. The address pattern is again based on a 2×2 group 1212 of elements 1214 within subarray 1220, with the difference being the larger number of groups 1212 in subarray 1220. (It should be noted that the address arrangements in FIG. 12A and FIG. 12B correspond to the arrangements of subarrays 542 and 642 shown in FIG. 5A and FIG. 6A.) As in FIG. 12A, additional subarrays 1220 for multiple tiles (Tile 0, Tile 1, . . . ) can be stored at successively higher addresses (e.g., the first element in the second tile can be located at the next address after the last element of the first tile). Addresses can thus be computed based on a tile offset, a group offset, and a row/column offset within the group. In some embodiments, the element width (TEW) is variable, and the offsets may be functions of TEW. For a given size of the tile state RAM, the number of tiles for which subarrays can be stored may also depend on TEW. Storing multiple tiles can reduce the swapping of tile state data between tile state RAM 242 and external memory and can also support reuse of operand data in the A and B operand buffers, e.g., in connection with adjacent tiles 340 of the product matrix.

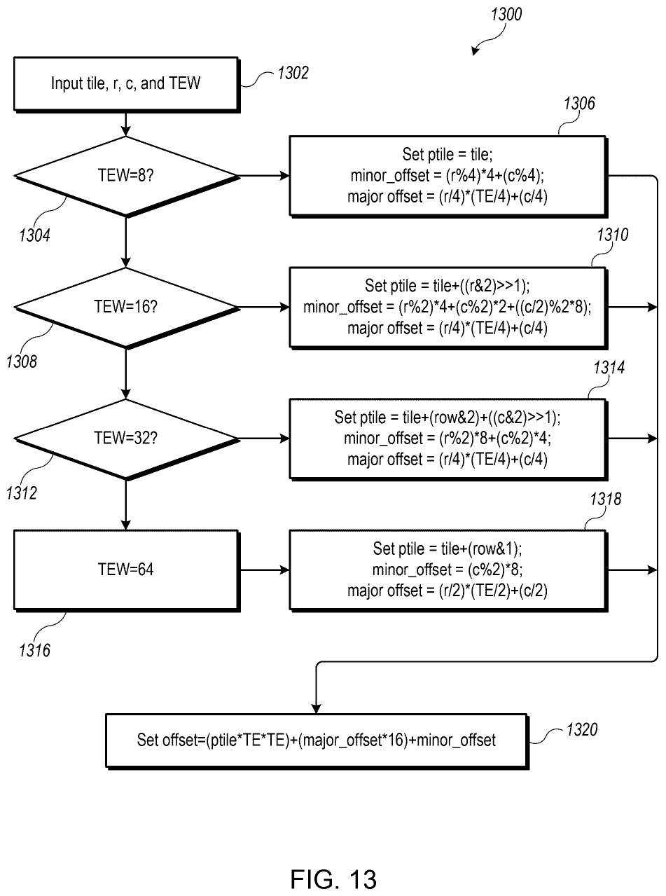

To further illustrate tile-based addressing, FIG. 13 shows a flow diagram of a process 1300 for computing the address of an element in tile state RAM 242 according to some embodiments. Process 1300 can be implemented, e.g., using hardware circuits within cells 240 or other components of matrix multiply engine 120. In this example, the tile state RAM is treated as a linearized buffer of size 16*TE*TE bytes. The address of an element within the buffer depends on its tile number (variable tile) and its position within the tile, defined as a row (variable r) and column (variable c), as well as the tile element size TEW. Three offset components, denoted as ptile, minor_offset, and major_offset are computed using formulas that depend on TEW. These offset components are then combined to determine an address offset (offset) in the linearized buffer corresponding to the element. At block 1302, values of the variables tile, r, c, and TEW are input. If, at block 1304, TEW=8, then offset components ptile, minor_offset, and major_offset are computed as shown at block 1306. (In the notation used in FIG. 13, “%” is a modulo operator.) If, at block 1308, TEW=16, then offset components ptile, minor_offset, and major_offset are computed as shown at block 1310. (In the notation used in FIG. 13, “>>” is a right-shift operator and “&” is a bitwise AND operator). If, at block 1312, TEW=32, then offset components ptile, minor_offset, and major_offset are computed as shown at block 1314. If, at block 1316, TEW=64, then offset components ptile, minor_offset, and major_offset are computed as shown at block 1318. At block 1320, the offset is computed as a function of ptile, minor_offset, major_offset, and TE (which is a fixed parameter of the hardware). It should be understood that process 1300 is illustrative. Arrangement of element data within tile state RAM 242 can be varied, and appropriate addressing computations can be applied.

In various embodiments, additional memory management techniques such as double buffering and bank interleaving can be employed to further increase memory access efficiency and throughput. For instance, improved performance for small matrices can be obtained by pairwise interleaving of product matrix elements.

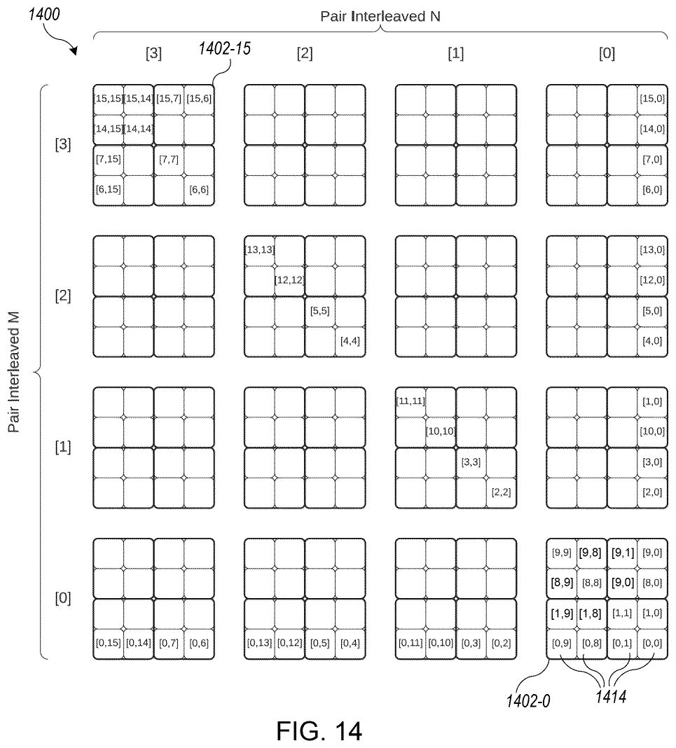

FIG. 14 shows an example of element interleaving in a cell array according to some embodiments. Shown is a representation of the tile state memory 1400 across a 4×4 cell array that can store elements of a 16×16 product matrix (TE=6). In this case, TE_CELL=4, and each tile 1402-0 through 1402-15 in tile state memory 1400 includes a 4×4 array of storage locations 1414 for matrix elements. Storage addresses can be assigned based on 2×2 groups, following the arrangement shown in FIG. 12A. The coordinate pair (e.g., [0,0]) in particular element storage locations 1414 indicates the matrix element mapped to that location. As illustrated, elements are interleaved in pairs. For instance, elements [0,0] and [0,1], which have adjacent positions in the matrix are at adjacent locations in the memory address space, then elements [0,8] and [0,9] (which are not adjacent to elements [0,0] and [0,1] in the matrix) are interleaved in the next memory locations. While mappings to memory locations are not expressly shown for all matrix elements, the interleaving pattern can be understood from FIG. 14.

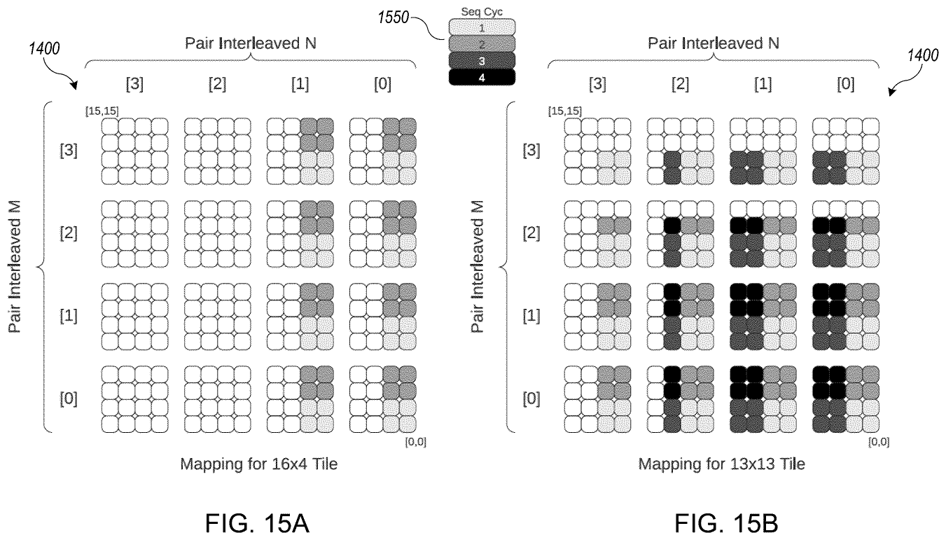

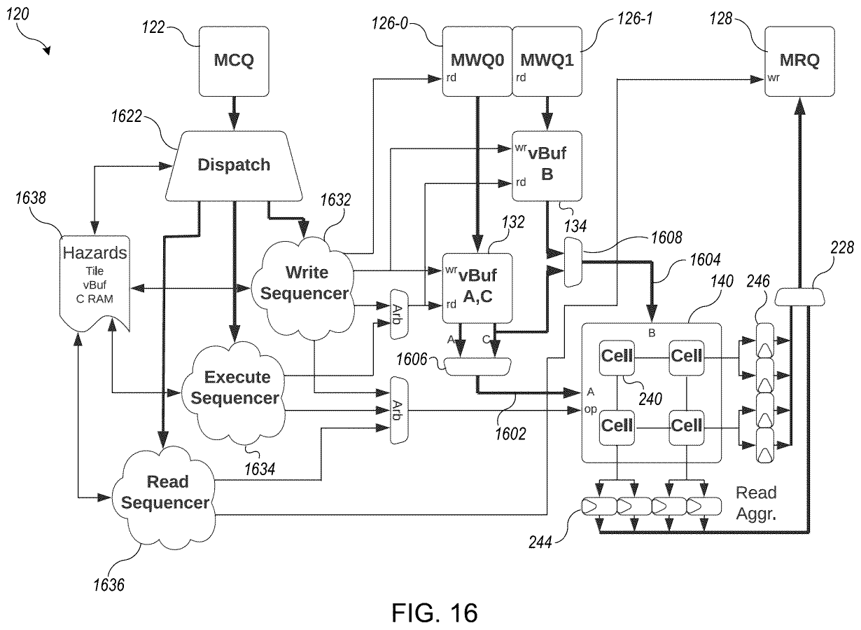

FIGS. 15A and 15B illustrate how element interleaving according to some embodiments can improve performance for a small matrix as well as distributing energy dissipation across the cells. FIG. 15A shows which memory locations in tile state memory 1400 are used for a 16×4 tile where the interleaving pattern follows that shown in FIG. 14. Element storage locations that are used are shaded; unshaded locations are not used. In some embodiments, all elements can be computed in two cycles, and lighter shading indicates elements computed during cycle 1 while darker shading indicates elements computed during cycle 2 (as shown in legend 1550). Similarly, FIG. 15B shows which memory locations in tile state memory 1400 are used for a 13×13 tile where the interleaving pattern follows that shown in FIG. 14. Element storage locations that are used are shaded; unshaded locations are not used. In some embodiments, all elements can be computed in four cycles; the cycle during which each element is computed is indicated by the darkness of shading, as shown in legend 1550. In these examples, each tile 1402 is associated with a different cell 240 in cell array 140, and FIGS. 15A and 15B illustrate how interleaving for small matrices can distribute computational load (and memory access) more evenly across cell array 140.

It should be understood that the interleaving arrangement of FIG. 14 can be applied if desired, regardless of matrix size. In some embodiments, interleaving can be applied selectively, e.g., for tiles at the edges of a large matrix.

### Control Path and Instructions

Referring again to FIG. 1, operation of matrix multiply engine 120 can be controlled by providing a sequence of instructions, including instructions to read portions of operand matrices into operand buffers 132, 134 and C buffer 136; instructions to execute a multiply-accumulate operation in the cells; and instructions to read data from cell array 140 (e.g., from tile state RAM 142) for writing to external memory (e.g., system memory or other memory external to matrix multiply engine 120). For instance, specific instructions can include:

(1) memory instructions to load data from external memory into tile state RAM 142, to store data from tile state RAM 142 into external memory, to move data from a vector register group in vector register file 116 into tile state RAM 142, and to move data from tile state RAM 142 into a vector register group in vector register file 116;

(2) arithmetic instructions, in particular matmul instructions that cause cells to read operands having a particular format (which can be specified in the instruction) from a portion of operand buffers 132, 134 and perform multiply-accumulate operations into tile state RAM 142 as described above; and

(3) Configuration instructions to compute or update runtime configurable parameters such as SEW, TEW, TK, TM, TN, and so on.

In some embodiments, configuration instructions can include loading of the runtime parameters into control and status registers (not shown) of matrix multiply engine 120. If desired, such configuration instructions can be executed by a processor external to matrix multiply engine 120, provided that matrix multiply engine 120 can read the control and status registers.

FIG. 16 shows a simplified block diagram of matrix multiply engine 120 including control paths according to some embodiments. As described above, matrix multiply engine 120 includes operand buffers 132, 134 and cell array 140 having cells 240. In this example, operand A buffer 132 also receives elements of tile state C when tile state is being swapped in and out of local RAM (e.g., tile state RAM 242) in cells 240. Command queue (MCQ) 122 receives a sequence of instructions in order from an instruction source, which can be, e.g., vector instruction unit 112 as shown in FIG. 1, and delivers the instructions in order to a dispatch unit 1622.

Dispatch unit 1622 issues instructions received from command queue 122 in order to one or more of a set of sequencers 1632, 1634, 1636, depending on instruction type. For instance, instructions that involve writing data from external buffers or external memory to operand buffers 132, 134 or to tile state RAM 142 (shown in FIG. 2) can be issued to write sequencer 1632. Instructions that involve executing arithmetic instructions can be issued to execute sequencer 1634. Instructions that involve reading from tile state RAM 142 into read queue 128 can be issued to read sequencer 1636.

Each sequencer 1632, 1634, 1636 can include control logic to provide commands and data together, and in order, through the various interface queues. Sequencers 1632, 1634, 1636 can employ hazard logic 1638 to avoid head-of-line blocking and maximize parallelism. Hazard logic 1638 can provide operational awareness, e.g., by preventing a circuit from reading data before it is ready or by allocating a write port of tile state RAM 142 for a future cycle when the associated read port is granted (e.g., to assure that multiply-accumulate operations can write their data back to tile state RAM 142 when computations are complete).

In some embodiments, write sequencer 1632 receives both arithmetic instructions and instructions that write from external memory to tile state RAM 142. For arithmetic operations, write sequencer 1632 can coordinate the transfer of write data from write queues 126-0, 126-1 to operand buffers 132, 134 and mark operand buffers 132, 134 as valid once data transfer is complete. For a tile state write from external memory, write sequencer 1632 can transfer data from A buffer 132 (which also serves as the C buffer in this example) to cells 240, arbitrate for access to the destination tile state RAM bank (e.g., RAM banks in cells 240 as described above), and issue the write operation once access is granted. As described with reference to FIG. 4D, write units 432 can transfer to tile state RAM 442, e.g., using RMW circuit 482, which can allow a write to update only a portion of a tile in tile state RAM 442. In some embodiments, a write can be issued to either a row or column of cells. In circuit 400, row writes can use the B bus 404, while column writes use the A bus 402. Depending on SEW size, multiple bus cycles can be used to transfer the data from buffer 132 to cells 240.

In some embodiments, read sequencer 1636 receives instructions to read a row or column from tile state RAM 242. Read sequencer 1636 can first verify that read queue 128 has space to accommodate the request, then arbitrate for the source bank in tile state RAM 242. Once access is granted, read sequencer 1636 can initiate reading from tile state RAM 242 and aggregating the data in registers 244 (for rows) or registers 246 (for columns). Once the read is complete, read sequencer 1636 can push the data from registers 244 or registers 246 to read queue 128.

In some embodiments, execution sequencer 1634 receives arithmetic instructions, in particular matmul instructions. Execution sequencer 1634 can wait for operand buffers 132, 134 to become valid (which occurs when write sequencer 1632 completes writing to the buffers); arbitrate for operand buses (e.g., buses 1602, 1604); and transfer data via operand buses 1602, 1604 to buffers within cells 240. Once operand data is in cells 240, execution sequencer 1634 can arbitrate for access to the read port of relevant banks in tile state RAM 24. Once read-port access is granted, execution sequencer 1634 can enable accumulator logic 241 in cells 240 to begin an operation cycle. Execution sequencer 1634 can repeat these operations for all cycles required to complete the instruction (e.g., 2-16 cycles in examples in FIGS. 5A, 5B, 6A, and 6B). The particular number of cycles can be determined, e.g., based on operand width and TE_CELL. In some embodiments, the number of cycles can be reduced if a matrix edge is encountered.

Not all cells 240 in cell array 140 need to participate in each operation. Accordingly, in some embodiments, each row and column of cells 240 can have an independent collection of enable and operation signals to support up to two concurrent operations, such as a read operation concurrent with either a write operation or an execute (matmul) operation. Within each cell 240, a cross product of enable signals, together with the particular operation signal, can be used to determine whether that cell 240 participates.

It should be noted that matrix transpose can be accomplished by first issuing instructions to write rows from a matrix into rows of tile state RAM 242, then instructions to read columns from tile state RAM 242. Appropriate instructions can be included in the instruction sequence delivered to command queue 122.

Various efficiency enhancements can also be implemented if desired. For example, some access operations to tile state RAM 142 can be squashed. In some embodiments, if a particular operation is a write and all elements of the RAM word are participating in the write, the state read can be squashed, which allows a concurrent read operation to use that cycle.

In some embodiments, dispatch unit 1622 can support power management features, e.g., to prevent sudden changes in power consumption or overheating of circuitry. For instance, it may be desirable to ramp up power consumption slowly, e.g., by performing a warm-up phase prior to normal operation. In the warmup phase, dummy operands can be injected into the ALUs of an increasing subset of cells 240 over a number of cycles. Dispatch unit 1622 can issue appropriate instructions (using injected operands) to execute the warmup, and results can be discarded. Similarly, during idle cycles (when command queue 122 has no instructions to execute), dispatch unit 1622 can keep a subset of ALUs in cells 240 active using injected operands. This can allow a slower ramp-down of power consumption toward zero. In some embodiments, power monitoring circuitry (not shown) can be used to monitor real-time power consumption of matrix multiply engine 120. If power consumption exceeds a target level, dispatch unit 1622 can begin injecting pipeline bubbles (e.g., by delaying issue of the next instruction), thereby reducing power consumption. Those skilled in the art will be aware of suitable power management techniques. Other techniques may also be used.

Integration into Processing Systems

A matrix multiply engine such as matrix multiply engine 120 can be integrated into a variety of processing systems. For instance, processing systems compatible with RISC-V standards include at least one processing core with zero or more coprocessors attached. In this context, a processing “core” has an independent instruction fetch unit and, if desired, can support multithreading. RISC-V defines a “hardware thread,” or “hart” as a processing context that has its own user register state and program counter. In some systems one core can support multiple harts. A “coprocessor” is a processing unit that attaches to a core and responds to instructions forwarded by the core. For instance, the coprocessor can be configured to execute instructions associated with a particular RISC-V extension. Accordingly, operations of a coprocessor are generally sequenced by the instruction stream that the core processes, although in some cases a coprocessor can have limited autonomy. A vector processor can be a coprocessor or a core, depending on implementation. Matrix multiply engine 120 can be implemented as a coprocessor, as described above.

According to some embodiments, a matrix multiply engine can be configured as a coprocessor that supports multiple harts, which may be distributed across multiple vector processors. Supporting multiple harts can increase utilization of matrix multiply engine 120.

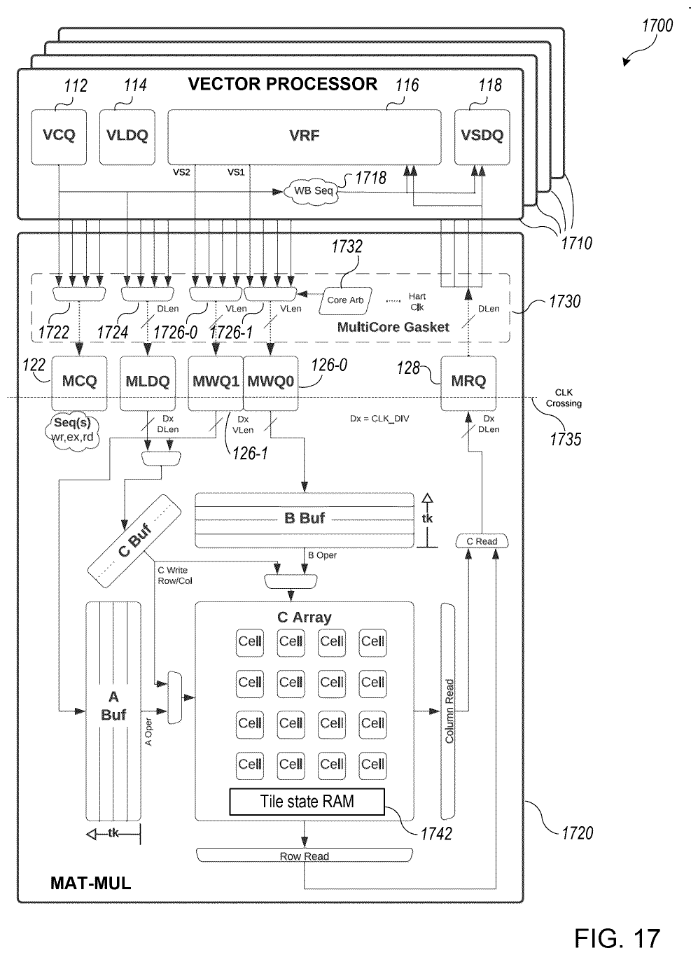

FIG. 17 shows a simplified block diagram of a system 1700 according to some embodiments. System 1700 includes a matrix multiply engine 1720 configured to support multiple vector processors 1710. Matrix multiply engine 1720 can be generally similar to matrix multiply engine 120 described above. Vector processors 1710 can represent different physical processors or one processor supporting multiple harts, or any combination thereof. Each vector processor 1710 can be similar to vector processor 110 described above and can include a vector instruction unit (VCQ) 112, a vector load queue 114, a vector register file 116, and a vector store queue 118. Also shown is a writeback sequencer 1718, which can coordinate writing of data from matrix multiply engine 1720 into vector register file 116 and/or vector store queue 118.

To interface with multiple vector processors 1710, matrix multiply engine 1720 can include a multi-core gasket 1730 that can sequence instructions and data received from different vector processors 1710. Multicore gasket 1730 includes a multiplexer 1722 that sequences instructions from vector instruction units 112 of different vector processors 1710 into command queue 122, thereby forming a single instruction stream to be executed in order by matrix multiply engine 1720. Similarly, multiplexers 1724, 1726-0, and 1726-1 sequence data from vector load queues 114 and vector register files 116 of different vector processors 1710 into load queue (MLDQ) 124 and write queues (MWQ0, MWQ1) 126-0, 126-1, providing a single stream of input data. Core arbitration logic 1732 coordinates operation of multiplexers 1722, 1724, 1726-0, and 1726-1 so that data ordering aligns with instruction ordering. While matrix multiply engine 1720 executes operations from the same vector processor 1710 (or hart) in order relative to each other, multicore gasket 1730 allows operations from different vector processors 1710 (or harts) to be interleaved as desired. In some embodiments, instructions delivered from the harts in vector processors 1710 to matrix multiply engine 1720 can include a “hartID” field; this parameter identifies the hart that was the source and facilitates routing of read data from read queue (MRQ) 128 back to the requesting hart. (It should be understood that one vector processor 1710 can support multiple harts, so the mapping of harts to vector processors 710 can be many-to-one.)

FIG. 17 also shows that matrix multiply engine 1720 and the attached vector processor(s) 1710 can operate in different clock domains. The clock domain boundary is indicated by a dashed line 1735; components above dashed line 1735 operate in the clock domain of vector processor(s) 1710 while components below dashed line 1735 operate in the clock domain of matrix multiply engine 1720. In some embodiments, both clock domains can have the same clock frequency. Alternatively, the clock frequencies can be different; for instance, matrix multiply engine 1720 can operate at half the clock frequency of vector processor(s) 1710.

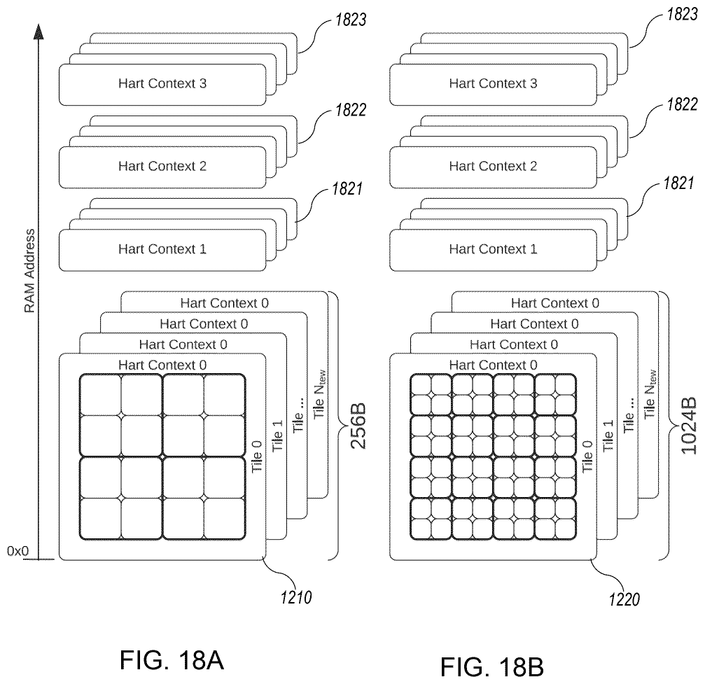

Efficient execution of interleaved instructions from different harts can be supported in part by expanding the capacity of the tile state RAM to store tile state data for multiple harts. FIGS. 18A and 18B show example of tile-based addressing in tile state RAM 1742 supporting multiple harts. In FIG. 18A, TE=4, and in FIG. 18B, TE=8. FIG. 18A (18B) extends the tile-based addressing scheme of FIG. 12A (12B) to include tile groups 1821, 1822, 1823 for additional harts. (The maximum number of harts supported can be selected as desired.) Thus, elements associated with the same hart can occupy contiguous addresses, and an address for a particular element of tile state can be computed in the manner described above with reference to FIG. 13, with the only difference being the addition of a hart offset that can be determined by multiplying the hartID by the size of the memory space allocated to each hart (e.g., 256 bytes in FIG. 18A, 1024 bytes in FIG. 18B).

### Configurability of Hardware

The foregoing examples are illustrative and can be modified. For instance, some of the parameters mentioned above are determined during design and fabrication of the hardware. Examples include: the vector register length (VLEN); the width of the data paths between the vector processor core(s) and the matrix multiply engine (MLEN, which can be equal to VLEN or can be a power of two factor of VLEN or the like); the number of tile elements in a row or column of the cell array (TE); the number of tile elements processed by each cell (TE_CELL); the number of harts that can share access to the matrix multiply engine (HART_NUM), a clock ratio between the harts and the matrix multiply engine (CLK_DIV); and the particular combination of operand formats supported, along with the corresponding KMAX (largest supported TK value) for each operand format. In some embodiments, the choice of these parameters does not affect the binary code; that is, assuming that different instances of matrix multiply engine 120 differ only in these parameters, the same binary code can be executed by all instances, although performance parameters such as throughput, execution time, power consumption, and chip area may vary. Accordingly, a combination of parameters can be selected in accordance with particular performance goals. In some embodiments, the design parameters can be chosen to optimize performance for a given operand width (e.g., TEW=32) subject to constraints such as chip area and available bandwidth for supplying operands to the matrix multiply engine.

It is contemplated that the circuit design of a particular matrix multiply engine (at the level of a component layout that can be fabricated into an integrated circuit) can be provided as a service, as described below. In some embodiments, different combinations of design parameters can be defined as a “profile” for a matrix multiply engine, with different profiles being optimized for different performance goals. A family of profiles can also be defined, in which some parameters are held constant across the family and other parameters vary.

As just one example, a family of profiles can be defined with following parameters held constant: VLEN=1024, MLEN=VLEN, TE=128; HART_NUM=4; CLK_DIV=2; and support for the following operand formats: (1) 14w8 (packed 4-bit signed/unsigned integer operands; TK=8); (2) 18w4 (8-bit signed/unsigned integer operands; KMAX=4); (3) FP8w4 (8-bit IEEE floating-point operands; KMAX=4); (4) FP16w2 (16-bit IEEE floating-point operands, KMAX=2); and (5) FP32 (32-bit IEEE floating-point operands; KMAX=1). Within this family, three profiles can be defined. Profile “A” can have TE_CELL=8 (which implies that cell array 140 includes a 16×16 array of cells 240) and no support for 64-bit operands (which can save chip area as there is no need for 64-bit multipliers in each cell). Profile “B” can differ from Profile A in having more cells. For instance, Profile B can have TE_CELL=4 (which implies that cell array 140 includes a 32×32 array of cells 240). Profile “C” can differ from Profile B in adding support for 64-bit floating-point operands. It will be appreciated that Profile A provides a baseline performance (with smaller chip area and power consumption) while Profiles B and C provide higher performance (with increasing chip area and power consumption). In some embodiments, profiles can be studied through simulation to estimate their performance characteristics, and a system designer can select an appropriate profile from a library.

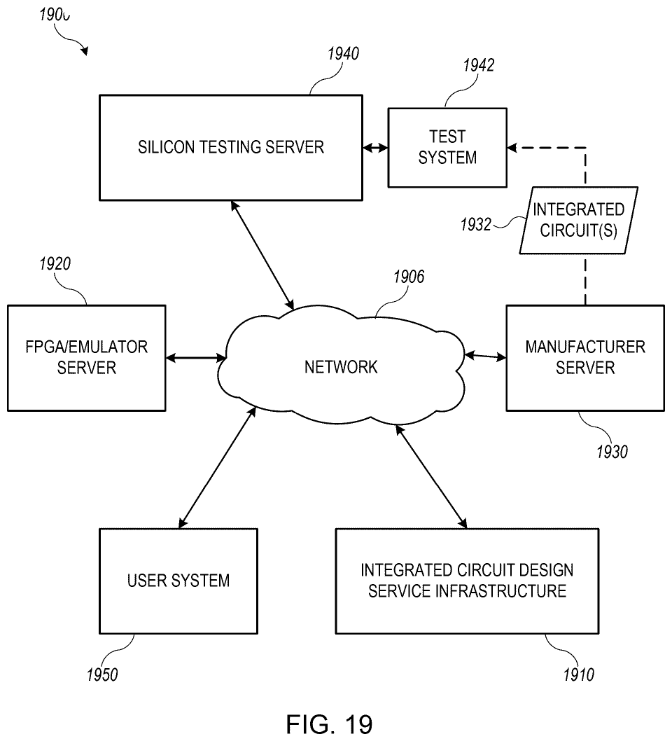

In this manner, design of a processing system that includes a matrix multiply engine of the kind described herein can be provided as a service. FIG. 19 shows a block diagram of a system 1900 for generation and manufacture of integrated circuits that can configure a matrix multiply engine according to some embodiments (such as matrix multiply engine 120) as well as other system components (e.g., a vector processor for which a matrix multiply engine is a coprocessor or a larger processing system that includes both the vector processor(s) and the matrix multiply engine). System 1900 includes an integrated circuit design service infrastructure 1910, a field programmable gate array (FPGA)/emulator server 1920, a manufacturer server 1930, a silicon testing server 1940, and a user system 1950 that communicate with each other via a network 1906, which can be, e.g., the internet, a private network, a local network, or any other type of network. Infrastructure 1910 and servers 1920, 1930, and 1940 can be implemented using general-purpose computer systems of appropriate scale.

A user may utilize a web client or a scripting application program interface (API) client executing on user system 1950 to command integrated circuit design service infrastructure 1910 to automatically generate an integrated circuit design based on a set of design parameter values selected by the user for one or more template integrated circuit designs. In some implementations, the template integrated circuit designs may include one or more templates for a matrix multiply engine (e.g., corresponding to on one or more profiles or families of profiles as described above). User system 1950 can construct a design parameter data structure, e.g., as a JavaScript Object Notation (JSON) file based on user specifications or selections, and communicate the design parameter data structure to integrated circuit design service infrastructure 1910 via network 1906.

Integrated circuit design service infrastructure 1910 can include a register-transfer level (RTL) service module configured to generate an RTL data structure for the integrated circuit based on a design parameters data structure. For example, the design parameter data structure can be processed to produce code in a hardware description language such as Scala or Chisel. The RTL service module can incorporate a Chisel compiler or the like to produce a flexible intermediate representation (FIR), which can be converted using a compiler such as the flexible intermediate representation for register-transfer level (FIRRTL) compiler to produce an RTL data structure (e.g., a Verilog file). RTL service module can also incorporate other design tools; for example, Diplomacy can facilitate generation of a parameterized protocol implementation such that multiple processor configurations can be generated from a single design with parameters specifying various features such as instruction set support (e.g., RV64, RV32 for RISC-V processors), bus and cache configurations, number of cores, and so on.

In some implementations, integrated circuit design service infrastructure 1910 can transmit the Verilog file to FPGA/emulation server 1920 (e.g., via network 1906). FPGA/emulation server 1920 can perform testing of the design by running one or more FPGAs or other types of hardware or software emulators. For example, FPGA/emulation server 1920 can perform a test using a field programmable gate array, programmed based on a field programmable gate array emulation data structure, to obtain an emulation result. Test results can be returned by the FPGA/emulation server 1920 to integrated circuit design service infrastructure 1910 and relayed in a useful format to the user, e.g., in a format that can be presented via a web client or a scripting API client executing on user system 1950.

Integrated circuit design service infrastructure 1910 can also facilitate the manufacture of integrated circuits using the integrated circuit design. For instance, integrated circuit design service infrastructure 1910 can transmit a physical design specification to a manufacturer server 1930 that is associated with a manufacturing facility capable of fabricating integrated circuits. In some implementations, the physical design specification can be in the form of a graphic data system (GDS) file, such as a GDSII file, which integrated circuit design service infrastructure 1910 can generate from an RTL data structure in response to user approval of a particular design. Manufacturer server 1930 can initiate manufacturing of the integrated circuit (e.g., using manufacturing equipment of the associated manufacturing facility). For example, manufacturer server 1930 may host a foundry tape-out website that is configured to receive physical design specifications (such as a GDSII file or an open artwork system interchange standard (OASIS) file) and can schedule or otherwise facilitate fabrication of integrated circuits. In some implementations, integrated circuit design service infrastructure 1910 supports multi-tenancy to allow multiple integrated circuit designs (e.g., from one or more users) to share fixed costs of manufacturing (e.g., reticle/mask generation, and/or shuttles wafer tests). For example, integrated circuit design service infrastructure 1910 may use a fixed package (e.g., a quasi-standardized packaging) that is defined to reduce fixed costs and facilitate sharing of reticle/mask, wafer test, and other fixed manufacturing costs. A physical design specification generated by integrated circuit design service infrastructure 1910 can include one or more physical designs from one or more respective physical design data structures in order to facilitate multi-tenancy manufacturing.

After receiving the physical design specification, the manufacturer associated with the manufacturer server 1930 may fabricate and/or test integrated circuits based on the integrated circuit design. For example, the associated manufacturer (e.g., a foundry) may perform optical proximity correction (OPC) and similar post-tape-out/pre-production processing, fabricate a number of integrated circuit(s) 1932, update integrated circuit design service infrastructure 1910 (e.g., via communications with a controller or a web application server) periodically or asynchronously on the status of the manufacturing process, perform appropriate testing (e.g., wafer testing), and send integrated circuits 1932 to a packaging house for packaging. A packaging house (not shown in FIG. 2) can receive the finished wafers or dice from the manufacturer and can test materials and update integrated circuit design service infrastructure 1910 on the status of the packaging and delivery process periodically or asynchronously. In some implementations, status updates may be relayed to user system 1950 when the user checks in using a web interface, and/or integrated circuit design service infrastructure 1910 can notify the user of updates.

In some implementations, integrated circuit(s) 1932 (e.g., physical chips) can be delivered (e.g., via mail) to a silicon testing service provider associated with a silicon testing server 1940. In some implementations, resulting integrated circuit(s) 1932 (e.g., physical chips) are installed in a test system 1942 controlled by silicon testing server 1940, and silicon testing server 1940 can support remote operation of test system 1942 via network 1906. For example, silicon testing server 1940 can establish an account that controls test system 19420 to test integrated circuit(s) 1932. Account login information can be sent to integrated circuit design service infrastructure 1910 and relayed to user system 1950. As another example, integrated circuit design service infrastructure 1910 may be used to control testing of one or more integrated circuit(s) 1932.

Integrated circuit design service infrastructure 1910, FPGA/emulator server 1920, manufacturing server 1930, and silicon testing server 1940 can be operated by the same entity or different entities as desired. In this example, the user can interact directly with integrated circuit design service infrastructure 1910, which can serve as an intermediary to other services and service providers. Other implementations are also possible. For instance, a user can operate an integrated circuit design service infrastructure locally to generate graphic data system files, send the graphic data system files to a manufacturer, receive integrated circuits for testing, and perform tests locally. Alternatively, some operations may be performed locally while other operations are performed remotely.

In some embodiments, computer systems that facilitate generation of integrated circuits can include computer systems of generally conventional design. Such systems may include one or more processors to execute program code (e.g., general purpose microprocessors usable as a central processing unit (CPU) and/or special purpose processors such as graphics processors (GPUs) that may provide enhanced parallel processing capability); memory and other storage devices to store program code and data; user input devices (e.g., keyboards, pointing devices such as a mouse or touchpad, microphones); user output devices (e.g., display devices, speakers, printers); combined input/output devices (e.g., touchscreen displays); signal input/output ports; network communication interfaces (e.g., wired network interfaces such as Ethernet interfaces and/or wireless network communication interfaces such as Wi Fi); and so on. Computer systems can be implemented in a variety of form factors and with varying quantities of processor resources. For instance, user system 1950 can be a consumer device such as a desktop computer, laptop computer, tablet computer, mobile device (e.g., smart phone), or the like. Integrated circuit design service infrastructure 1910, FPGA/emulation server 1920, manufacturer server 1930 and silicon testing server 1940 can be implemented using more powerful server systems or server farms and can be implemented using cloud-based services (e.g., virtual servers) rather than dedicated server hardware.

A non-transitory computer readable medium may store a circuit representation that, when processed by a computer, is used to program or manufacture an integrated circuit. For example, the circuit representation may describe the integrated circuit specified using a computer readable syntax. The computer readable syntax may specify the structure or function of the integrated circuit or a combination thereof. In various implementations, or at various stages of the design process, the circuit representation may take the form of a hardware description language (HDL) program, an RTL data structure, a flexible intermediate representation for register-transfer level (FIRRTL) data structure, a Graphic Design System II (GDSII) data structure, a netlist, or a combination thereof. In some implementations, the integrated circuit may take the form of a field-programmable gate array (FPGA), an application-specific integrated circuit (ASIC), a system on a chip (SoC), or some combination thereof. A computer may process the circuit representation in order to program or manufacture an integrated circuit, which may include programming an FPGA or manufacturing an ASIC or an SoC. In some implementations, the circuit representation may include a file that, when processed by a computer, may generate a new description of the integrated circuit. For example, the circuit representation can be written in a language such as Chisel, an HDL embedded in Scala, a statically typed general purpose programming language that supports both object-oriented programming and functional programming. A Chisel language program can be executed by a computer to produce a circuit representation expressed in a FIRRTL data structure. In some implementations, a design flow of processing steps may be utilized to process the circuit representation into one or more intermediate circuit representations, followed by a final circuit representation that is usable to program or manufacture an integrated circuit. In one example, a circuit representation in the form of a Chisel program may be stored on a non-transitory computer readable medium and may be processed by a computer to produce a FIRRTL circuit representation. The FIRRTL circuit representation may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit. In another example, a circuit representation in the form of Verilog or VHDL may be stored on a non-transitory computer readable medium and may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit. The foregoing steps may be executed by the same computer, different computers, or some combination thereof, depending on the implementation.

The foregoing examples illustrate how integrated circuits incorporating functionality and/or components described herein can be designed and manufactured. It should be understood that other processes and techniques can also be used.

### ADDITIONAL EMBODIMENTS

While the invention has been described with reference to specific embodiments, those skilled in the art will appreciate that variations and modifications are possible. For instance, various design parameters including the number of cells in the cell array, size of vector registers, size of tile state RAM, combination of data formats supported, and the like can all be modified. Examples described herein make specific reference to RISC-V standards; however, embodiments are not limited to any particular instruction set architecture or other standards.

While various circuits and components are described herein with reference to particular blocks, it is to be understood that these blocks are defined for convenience of description and are not intended to imply a particular physical arrangement of component parts. The blocks need not correspond to physically distinct components, and the same physical components can be used to implement aspects of multiple blocks. Components described as dedicated or fixed-function circuits can be configured to perform operations by providing a suitable arrangement of circuit components (e.g., logic gates, registers, switches, etc.); automated design tools can be used to generate appropriate arrangements of circuit components implementing operations described herein. Components described as processors, microprocessors, coprocessors or the like can be configured to perform operations described herein by providing suitable program code. Various blocks might or might not be reconfigurable depending on how the initial configuration is obtained. Embodiments of the present invention can be realized in a variety of apparatus including electronic devices implemented using a combination of circuitry and software.

All processes described herein are also illustrative and can be modified. Operations can be performed in a different order from that described, to the extent that logic permits; operations described above may be omitted or combined; and operations not expressly described above may be added.

Computer programs incorporating features of the present invention that can be implemented using program code may be encoded and stored on various computer readable storage media; suitable media include magnetic disk or tape, optical storage media such as compact disk (CD) or DVD (digital versatile disk), flash memory, and other non-transitory media. In some instances, program code can be supplied via Internet download or other (transitory) signal transmission.

All numerical values and ranges provided herein are illustrative and may be modified. Unless otherwise indicated, drawings should be understood as schematic and not to scale.

Accordingly, although the invention has been described with respect to specific embodiments, it will be appreciated that the invention is intended to cover all modifications and equivalents within the scope of the following claims.

1. (canceled)

2. A method comprising:
receiving at an integrated circuit design computer system, via a network interface, an instruction to build an integrated circuit that includes a matrix multiply engine, the instruction including a design parameter data structure specifying design parameters of the integrated circuit;
responsive to the instruction and the design parameter data structure, generating, using the integrated circuit design computer system, a register-transfer level (RTL) data structure for an integrated circuit that includes the matrix multiply engine;
responsive to the instruction, automatically generating, using the integrated circuit design computer system, a physical design specification for the integrated circuit based on the RTL data structure, the physical design specification including specifications for logic circuits implementing:
a first operand buffer and a second operand buffer each having storage locations for a plurality of operand elements, the storage locations being arranged in a plurality of rows and a plurality of columns;
a cell array comprising a plurality of cells, each cell including:
a memory comprising addressable memory circuitry to store one or more tile state elements; and
accumulator circuitry to receive a plurality of operand elements from each of the first operand buffer and the second operand buffer, to compute a dot product of the received operand elements, and to accumulate the dot product into a corresponding tile state element in the memory;
operand writing circuitry configured to load operand elements corresponding to matrix elements from one or more rows of a first input matrix into one or more of the rows of the first operand buffer and to load operand elements corresponding to matrix elements from one or more rows of a second input matrix into one or more of the rows of the second operand buffer;
a first data bus configured to provide a first column vector comprising a number (TK) of operand elements from at least one of the columns of the first operand buffer to one or more of the cells in the cell array;
a second data bus configured to provide a second column vector comprising the number TK of operand elements from at least one of the columns of the second operand buffer to one or more of the cells in the cell array, wherein the number TK depends on a width of the operand elements; and
readout circuitry configured to read out the memory of the cells; and
transmitting, storing, or displaying the physical design specification.

3. The method of claim 2 further comprising:
transmitting the physical design specification to a manufacturer server,
wherein the manufacturer server fabricates at least one integrated circuit based on the physical design specification.

4. The method of claim 3 further comprising:
providing the at least one integrated circuit to a testing system,
wherein the testing system performs tests on the at least one integrated circuit.

5. The method of claim 2 wherein the physical design specification is generated such that the width of the operand elements is a runtime parameter (SEW) specified for a particular matrix product computation.

6. The method of claim 5 wherein the physical design specification is generated such that, for a first value of the runtime parameter SEW, the number TK is at least 4, for a second value of the runtime parameter SEW, the number TK is at least 2, and for a third value of the runtime parameter SEW, the number TK is 1.

7. The method of claim 2 further comprising:
defining a plurality of profiles, wherein each profile corresponds to a different combination of design parameter values for the matrix multiply engine; and
storing the plurality of profiles at the integrated circuit design computer system.

8. The method of claim 7 wherein generating the RTL data structure includes:
extracting a profile identifier from the design parameter data structure; and
using the profile identifier to select one of the stored profiles to use for generating the RTL data structure corresponding to the matrix multiply engine.

9. The method of claim 2 wherein the physical design specification is generated such that the accumulator circuitry includes:
a plurality of dot-product circuits to compute dot products of pairs of column vectors having different numbers TK of operand elements; and
a scalar product circuit to compute a product of a pair of column vectors having one operand element each.

10. The method of claim 9 wherein the physical design specification is generated such that the plurality of dot-product circuits are configured to operate on both integer and floating-point operands.

11. The method of claim 2 wherein the physical design specification is generated such that the cells in the cell array are arranged in rows and columns of cells and the readout circuitry is configured to selectably read data from either a row or a column of cells.

12. A system comprising:
a network interface;
a memory; and
one or more processors coupled to the network interface and the memory, the one or more processors being configured to:
receive, via the network interface, an instruction to build an integrated circuit that includes a matrix multiply engine, the instruction including a design parameter data structure specifying design parameters of the integrated circuit;
generate, responsive to the instruction and the design parameter data structure, a register-transfer level (RTL) data structure for an integrated circuit that includes the matrix multiply engine;
generate, responsive to the instruction, a physical design specification for the integrated circuit based on the RTL data structure, the physical design specification including specifications for logic circuits implementing:
a first operand buffer and a second operand buffer each having storage locations for a plurality of operand elements, the storage locations being arranged in a plurality of rows and a plurality of columns;
a cell array comprising a plurality of cells, each cell including a memory comprising addressable memory circuitry to store one or more tile state elements, and accumulator circuitry to receive a plurality of operand elements from each of the first operand buffer and the second operand buffer, to compute a dot product of the received operand elements, and to accumulate the dot product into a corresponding tile state element in the memory;
operand writing circuitry configured to load operand elements corresponding to matrix elements from one or more rows of a first input matrix into one or more of the rows of the first operand buffer and to load operand elements corresponding to matrix elements from one or more rows of a second input matrix into one or more of the rows of the second operand buffer;
a first data bus configured to provide a first column vector comprising a number (TK) of operand elements from at least one of the columns of the first operand buffer to one or more of the cells in the cell array;
a second data bus configured to provide a second column vector comprising the number TK of operand elements from at least one of the columns of the second operand buffer to one or more of the cells in the cell array, wherein the number TK depends on a width of the operand elements; and
readout circuitry configured to read out the memory of the cells; and
transmit, store, or display the physical design specification.

13. The system of claim 12, wherein the one or more processors are further configured to transmit the physical design specification to a manufacturer server that fabricates at least one integrated circuit based on the physical design specification.

14. The system of claim 12 wherein the one or more processors are further configured such that the physical design specification specifies that the width of the operand elements is a runtime parameter (SEW) specified for a particular matrix product computation.

15. The system of claim 14 wherein the one or more processors are further configured such that the physical design specification specifies that, for a first value of the runtime parameter SEW, the number TK is at least 4, for a second value of the runtime parameter SEW, the number TK is at least 2, and for a third value of the runtime parameter SEW, the number TK is 1.

16. The system of claim 12 wherein the memory stores a plurality of profiles, each profile corresponding to a different combination of design parameter values for the matrix multiply engine.

17. The system of claim 16 wherein the one or more processors are further configured such that generating the RTL data structure includes:
extracting a profile identifier from the design parameter data structure; and
using the profile identifier to select one of the stored profiles to use for generating the RTL data structure corresponding to the matrix multiply engine.

18. The system of claim 12 wherein the one or more processors are further configured such that the physical design specification specifies that the accumulator circuitry includes:
a plurality of dot-product circuits to compute dot products of pairs of column vectors having different numbers TK of operand elements; and
a scalar product circuit to compute a product of a pair of column vectors having one operand element each.

19. The system of claim 12 wherein the one or more processors are further configured such that the physical design specification specifies that the plurality of dot-product circuits are configured to operate on both integer and floating-point operands.

20. The system of claim 12 wherein the one or more processors are further configured such that the physical design specification specifies that the cells in the cell array are arranged in rows and columns of cells and the readout circuitry is configured to selectably read data from either a row or a column of cells.
